(19) United States
(12) Patent Application Publication
(10) Pub. No.: US 2024/0227868 A9
(43) Pub. Date: Jul. 11, 2024

(54) PRESENTATION CONTROL DEVICE, AND AUTOMATED DRIVE CONTROL DEVICE

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/402,223

(22) Filed: Jan. 2, 2024

Related U.S. Application Data
(63) Continuation of application No. PCT/JP22/22763, filed on Jun. 6, 2022.

(30) Foreign Application Priority Data
Jul. 5, 2021 (JP) 2021-111689
Nov. 22, 2021 (JP) 2021-189630
Mar. 30, 2022 (JP) 2022-056862

(51) Int. Cl. B60W 60/00; B60W 50/00; B60W 50/14

(52) U.S. Cl. CPC B60W 60/0057; B60W 50/0097; B60W 50/14; B60W 60/0015; B60W 60/0053; B60W 2554/406

(57) ABSTRACT

An automated drive control device that enables traveling of a subject vehicle by an automated driving function is provided. The automated drive control device is configured to determine whether an elapsed time after the stop exceeds a predetermined time when the subject vehicle that has been traveling by autonomous traveling control in which a driver of the subject vehicle is not obliged to monitor periphery stops due to congestion, cause an input by the driver to not be required for resuming the traveling of the subject vehicle when the elapsed time does not exceed the predetermined time, and resume the traveling of the subject vehicle on a basis of an input by the driver when the elapsed time exceeds the predetermined time.

### CROSS REFERENCE TO RELATED APPLICATIONS

The present application is a continuation application of International Patent Application No. PCT/JP2022/022763 filed on Jun. 6, 2022 which designated the U.S. and claims the benefit of priority from Japanese Patent Application No. 2021-111689 filed on Jul. 5, 2021, Japanese Patent Application No. 2021-189630 filed on Nov. 22, 2021, and Japanese Patent Application No. 2022-56862 filed on Mar. 30, 2022. The entire disclosures of all of the above applications are incorporated herein by reference.

### TECHNICAL FIELD

The disclosure in this description relates to a control technology for information presentation related to an automated driving function and a technology for enabling traveling by the automated driving function.

### BACKGROUND

A related art describes a vehicle control device that starts automated driving when congestion whose length is equal to or longer than a predetermined value occurs.

### SUMMARY

According to one example of the present disclosure, an automated drive control device that enables traveling of a subject vehicle by an automated driving function is provided. The automated drive control device is configured to determine whether an elapsed time after the stop exceeds a predetermined time when the subject vehicle that has been traveling by autonomous traveling control in which a driver of the subject vehicle is not obliged to monitor periphery stops due to congestion, cause an input by the driver to not be required for resuming the traveling of the subject vehicle when the elapsed time does not exceed the predetermined time, and resume the traveling of the subject vehicle on a basis of an input by the driver when the elapsed time exceeds the predetermined time.

### BRIEF DESCRIPTION OF DRAWINGS

Objects, features and advantages of the present disclosure will become more apparent from the following detailed description made with reference to the accompanying drawings. In the drawings:

FIG. 1 is a view illustrating an overall image of an in-vehicle network including an HCU according to a first embodiment of the present disclosure;

FIG. 2 is a block diagram illustrating details of an automated driving ECU;

FIG. 3 is a block diagram illustrating details of the HCU;

FIG. 4 is a table listing details of restarting control and information presentation;

FIG. 5 is a flowchart illustrating, together with FIG. 6, details of a starting control process executed by the automated driving ECU;

FIG. 6 is a flowchart illustrating, together with FIG. 5, details of the starting control process;

FIG. 7 is a flowchart illustrating details of a starting control process executed by a driving assistance ECU;

FIG. 8 is a flowchart illustrating details of a notification control process executed by the HCU and the like;

FIG. 9 is a table listing details of restarting control and information presentation in a second embodiment;

FIG. 10 is a flowchart illustrating details of the starting control process;

FIG. 11 is a flowchart illustrating details of the notification control process;

FIG. 12 is a table listing details of restarting control and information presentation in a third embodiment;

FIG. 13 is a table listing details of restarting control and information presentation in a fourth embodiment;

FIG. 14 is a flowchart illustrating, together with FIG. 5, details of the starting control process;

FIG. 15 is a flowchart illustrating details of a level 3 return process;

FIG. 16 is a flowchart illustrating details of a notification execution process prepared for level 2;

FIG. 17 is a flowchart illustrating details of a notification execution process prepared for congestion level 3;

FIG. 18 is a flowchart illustrating, together with FIG. 5, details of a starting control process in a fifth embodiment;

FIG. 19 is a flowchart illustrating details of the level 3 return process;

FIG. 20 is a table listing details of restarting control and information presentation in a sixth embodiment;

FIG. 21 is a flowchart illustrating details of the starting control process;

FIG. 22 is a flowchart illustrating details of the notification control process;

FIG. 23 is a flowchart illustrating details of a notification execution process prepared for stop by low-G emergency avoidance control or stop in congestion;

FIG. 24 is a flowchart illustrating details of a notification execution process prepared for stop by high-G emergency avoidance control;

FIG. 25 is a flowchart illustrating details of a starting control process in a seventh embodiment; and

FIG. 26 is a flowchart illustrating details of the notification control process.

### DETAILED DESCRIPTION

In recent years, a technology for enabling not only automated driving in which a driver is obliged to monitor periphery but also automated driving in which the driver is not obliged to monitor the periphery is being realized. When such automated driving without obligation to monitor the periphery is executed, the driver of a subject vehicle does not need to grasp the situation around the subject vehicle. Therefore, when the subject vehicle stops, for example, in a scene of traveling in congestion as in Patent Literature 1, the driver cannot know what to do after the stop because the driver does not grasp the situation around the subject vehicle. When such a scene occurs, there is a fear that the convenience of the automated driving without obligation to monitor the periphery may be impaired.

The present disclosure provides a presentation control device, a presentation control program, an automated drive control device, and an automated drive control program capable of ensuring the convenience of automated driving without obligation to monitor the periphery.

According to one aspect of the present disclosure, a presentation control device that is used in a subject vehicle capable of traveling by an automated driving function and controls presentation of information related to the automated driving function is provided. The presentation control device comprises: a control grasping section that grasps whether autonomous traveling control, in which a driver of the subject vehicle is not obliged to monitor periphery, is being executed by the automated driving function; and a notification control section that, when the subject vehicle that has been traveling by the autonomous traveling control stops, notifies traveling resumption information related to resumption of the traveling of the subject vehicle.

According to one aspect of the present disclosure, a presentation control program that is used in a subject vehicle capable of traveling by an automated driving function and controls presentation of information related to the automated driving function is provided. The presentation control program causing at least one processing section to execute a process includes: grasping whether autonomous traveling control, in which a driver of the subject vehicle is not obliged to monitor periphery, is being executed by the automated driving function; and notifying, when the subject vehicle that has been traveling by the autonomous traveling control stops, traveling resumption information related to resumption of the traveling of the subject vehicle.

In these aspects, when the subject vehicle that has been traveling by autonomous traveling control stops, traveling resumption information related to resumption of the traveling of the subject vehicle is notified. Therefore, even if the driver cannot grasp the situation around the subject vehicle, the driver can know an action after the stop from the traveling resumption information. As a result, the convenience of the automated driving without obligation to monitor the periphery can be ensured.

According to one aspect of the present disclosure, an automated drive control device that enables traveling of a subject vehicle by an automated driving function is provided. The automated drive control device comprises: a time determination section that, when the subject vehicle that has been traveling by autonomous traveling control in which a driver of the subject vehicle is not obliged to monitor periphery stops due to congestion, determines whether an elapsed time after the stop exceeds a predetermined time; and a traveling control section that, when the elapsed time does not exceed the predetermined time, causes an input by the driver to not be required for resuming the traveling of the subject vehicle and that, when the elapsed time exceeds the predetermined time, resumes the traveling of the subject vehicle on a basis of an input by the driver.

According to one aspect of the present disclosure, an automated drive control program that enables traveling of a subject vehicle by an automated driving function is provided. The automated drive control program causing at least one processing section to execute a process includes: measuring, when the subject vehicle that has been traveling by autonomous traveling control in which a driver of the subject vehicle is not obliged to monitor periphery stops due to congestion, an elapsed time after the stop; causing, when the elapsed time does not exceed a predetermined time, an input by the driver to not be required for restarting the subject vehicle; and restarting, when the elapsed time exceeds the predetermined time, the subject vehicle on a basis of an input by the driver.

In these aspects, when the subject vehicle that has been traveling by autonomous traveling control in which the driver is not obliged to monitor the periphery stops due to congestion, an input by the driver is not required for resuming the traveling of the subject vehicle if an elapsed time after the stop does not exceed a predetermined time. On the other hand, when the elapsed time after the stop exceeds the predetermined time, the traveling of the subject vehicle is resumed based on an input by the driver. According to the above, the situation around the subject vehicle needs to be grasped only in a scene where it is easy to ensure time for grasping the situation around the subject vehicle. Therefore, the driver can grasp an action to take over time. Therefore, the convenience of the automated driving without obligation to monitor the periphery can be ensured.

According to one aspect of the present disclosure, an automated drive control device that enables traveling of a subject vehicle by an automated driving function is provided. The automated drive control device comprises: a first traveling control section that controls the traveling of the subject vehicle by driving assistance control in which a driver of the subject vehicle is obliged to monitor periphery; and a second traveling control section that controls the traveling of the subject vehicle by autonomous traveling control in which the driver is not obliged to monitor the periphery. When the subject vehicle that has been traveling by the driving assistance control stops due to congestion, the first traveling control section causes an input by the driver to be required for restarting the subject vehicle on condition that an elapsed time after the stop exceeds a predetermined time. When the subject vehicle that has been traveling by the autonomous traveling control stops due to congestion, the second traveling control section causes an input by the driver to not be required for restarting the subject vehicle even if the elapsed time exceeds the predetermined time.

According to one aspect of the present disclosure, an automated drive control program that enables traveling of a subject vehicle by an automated driving function is provided. The automated drive control program causing at least one processing section to execute a process includes: causing, when the subject vehicle that has been traveling by driving assistance control in which a driver of the subject vehicle is obliged to monitor periphery stops due to congestion, an input by the driver to be required for restarting the subject vehicle on condition that an elapsed time after the stop exceeds a predetermined time; and causing, when the subject vehicle that has been traveling by autonomous traveling control in which the driver is not obliged to monitor the periphery stops due to congestion, an input by the driver to not be required for restarting the subject vehicle even when the elapsed time exceeds the predetermined time.

In these aspects, when the subject vehicle that has been traveling by autonomous traveling control without obligation to monitor the periphery stops due to congestion, an input by the driver is not required for restarting the subject vehicle even if the elapsed time after the stop exceeds the predetermined time. According to the above, a driver action like grasping the situation around the subject vehicle is also not required after the stop of the subject vehicle. Therefore, the convenience of the automated driving without obligation to monitor the periphery can be ensured.

According to one aspect of the present disclosure, an automated drive control device that enables traveling of a subject vehicle by an automated driving function is provided. The automated drive control device comprises: a time determination section that, when the subject vehicle that has been traveling by autonomous traveling control in which a driver of the subject vehicle is not obliged to monitor periphery stops due to congestion, determines whether an elapsed time after the stop exceeds a continuation time limit; and a traveling control section that, when the elapsed time exceeds the continuation time limit, causes the autonomous traveling control to make a transition to a standby state.

According to one aspect of the present disclosure, an automated drive control device that enables traveling of a subject vehicle by an automated driving function is provided. The automated drive control device comprises: a time determination section that, when the subject vehicle that has been traveling by autonomous traveling control in which a driver of the subject vehicle is not obliged to monitor periphery stops due to congestion, determines whether an elapsed time after the stop exceeds a continuation time limit; and a traveling control section that, when the elapsed time exceeds the continuation time limit, releases the autonomous traveling control. When an input of a specific resuming operation by the driver is grasped after the autonomous traveling control is released, the traveling control section returns a traveling control state of the subject vehicle to a state of the autonomous traveling control without going through a state of driving assistance control in which the driver is obliged to monitor the periphery.

According to one aspect of the present disclosure, an automated drive control program that enables traveling of a subject vehicle by an automated driving function is provided. The automated drive control program causing at least one processing section to execute a process includes: determining, when the subject vehicle that has been traveling by autonomous traveling control in which a driver of the subject vehicle is not obliged to monitor periphery stops due to congestion, whether an elapsed time after the stop exceeds a continuation time limit; and causing, when the elapsed time exceeds the continuation time limit, the autonomous traveling control to make a transition to a standby state.

According to one aspect of the present disclosure, an automated drive control program that enables traveling of a subject vehicle by an automated driving function is provided. The automated drive control program causing at least one processing section to execute a process including: determining, when the subject vehicle that has been traveling by autonomous traveling control in which a driver of the subject vehicle is not obliged to monitor periphery stops due to congestion, whether an elapsed time after the stop exceeds a continuation time limit; releasing, when the elapsed time exceeds the continuation time limit, the autonomous traveling control; and causing, when an input of a specific resuming operation by the driver is grasped after the autonomous traveling control is released, a traveling control state of the subject vehicle to return to the state of the autonomous traveling control without going through a state of driving assistance control in which the driver is obliged to monitor the periphery.

In these aspects, when the elapsed time after the stop due to congestion exceeds a continuation time limit, the autonomous traveling control makes a transition to a standby state or is brought into a released state in which return to the autonomous traveling control is possible by an input of the specific resuming operation by the driver. According to the above, the traveling of the subject vehicle by the autonomous traveling control can be resumed without requiring a complicated operation by the driver, and thus a situation, in which the driver does not know what to do after the stop, can be avoided. Therefore, the convenience of the automated driving without obligation to monitor the periphery can be ensured.

According to another aspect of the present disclosure, a non-transitory computer readable storage medium storing an automated drive control program that enables traveling of a subject vehicle by an automated driving function is provided. The automated drive control program causing at least one processing section to execute a process includes: measuring, when the subject vehicle that has been traveling by autonomous traveling control in which a driver of the subject vehicle is not obliged to monitor periphery stops due to congestion, an elapsed time after the stop; causing, when the elapsed time does not exceed a predetermined time, an input by the driver to not be required for restarting the subject vehicle; and restarting, when the elapsed time exceeds the predetermined time, the subject vehicle on a basis of an input by the driver.

According to another aspect of the present disclosure, a non-transitory computer readable storage medium storing an automated drive control program that enables traveling of a subject vehicle by an automated driving function is provided. The automated drive control program causing at least one processing section to execute a process includes: determining, when the subject vehicle that has been traveling by autonomous traveling control in which a driver of the subject vehicle is not obliged to monitor periphery stops due to congestion, whether an elapsed time after the stop exceeds a continuation time limit; and causing, when the elapsed time exceeds the continuation time limit, the autonomous traveling control to make a transition to a standby state.

According to another aspect of the present disclosure, a non-transitory computer readable storage medium storing an automated drive control program that enables traveling of a subject vehicle by an automated driving function is provided. The automated drive control program causing at least one processing section to execute a process includes: determining, when the subject vehicle that has been traveling by autonomous traveling control in which a driver of the subject vehicle is not obliged to monitor periphery stops due to congestion, whether an elapsed time after the stop exceeds a continuation time limit; releasing, when the elapsed time exceeds the continuation time limit, the autonomous traveling control; and causing, when an input of a specific resuming operation by the driver is grasped after the autonomous traveling control is released, a traveling control state of the subject vehicle to return to the state of the autonomous traveling control without going through a state of driving assistance control in which the driver is obliged to monitor the periphery.

According to another aspect of the present disclosure, a non-transitory computer readable storage medium storing an automated drive control program that enables traveling of a subject vehicle by an automated driving function is provided. The automated drive control program causing at least one processing section to execute a process includes: causing, when the subject vehicle that has been traveling by driving assistance control in which a driver of the subject vehicle is obliged to monitor periphery stops due to congestion, an input by the driver to be required for restarting the subject vehicle on condition that an elapsed time after the stop exceeds a predetermined time; causing, when the subject vehicle that has been traveling by autonomous traveling control in which the driver is not obliged to monitor the periphery stops due to congestion, an input by the driver to not be required for restarting the subject vehicle even when the elapsed time exceeds the predetermined time; grasping, when the subject vehicle that has been traveling by the autonomous traveling control stops by emergency avoidance, whether periphery monitoring by the driver is being executed; and resuming the traveling of the subject vehicle by the autonomous traveling control on condition that the driver is executing the periphery monitoring.

According to another aspect of the present disclosure, a non-transitory computer readable storage medium storing a presentation control program that is used in a subject vehicle capable of traveling by an automated driving function and controls presentation of information related to the automated driving function is provided. The presentation control program causing at least one processing section to execute a process includes: grasping whether autonomous traveling control, in which a driver of the subject vehicle is not obliged to monitor periphery, is being executed by the automated driving function; grasping, when the subject vehicle that has been traveling by the autonomous traveling control stops, whether periphery monitoring by the driver is being executed; notifying, when the driver is not executing the periphery monitoring, traveling resumption information related to resumption of the traveling of the subject vehicle; and omitting, when the driver is executing the periphery monitoring, the notification of the traveling resumption information.

According to another aspect of the present disclosure, a non-transitory computer readable storage medium storing a presentation control program that is used in a subject vehicle capable of traveling by an automated driving function and controls presentation of information related to the automated driving function is provided. The presentation control program causing at least one processing section to execute a process includes: grasping whether autonomous traveling control, in which a driver of the subject vehicle is not obliged to monitor periphery, is being executed by the automated driving function; notifying, when the subject vehicle that has been traveling by the autonomous traveling control stops, traveling resumption information related to resumption of the traveling of the subject vehicle; and starting, when the stop of the subject vehicle that has been traveling by the autonomous traveling control is predicted, a notification of the traveling resumption information before the subject vehicle stops.

According to another aspect of the present disclosure, a non-transitory computer readable storage medium storing a presentation control program that is used in a subject vehicle capable of traveling by an automated driving function and controls presentation of information related to the automated driving function is provided. The presentation control program causing at least one processing section to execute a process includes: grasping whether autonomous traveling control, in which a driver of the subject vehicle is not obliged to monitor periphery, is being executed by the automated driving function; notifying, when the subject vehicle that has been traveling by the autonomous traveling control stops, traveling resumption information related to resumption of the traveling of the subject vehicle; requesting, when the subject vehicle that has been traveling by a driving assistance control in which the driver is obliged to monitor the periphery stops due to congestion, a driver input for restarting the subject vehicle on a basis of a lapse of a predetermined time from the stop, and cancelling, when the subject vehicle that has been traveling by the autonomous traveling control stops due to congestion, the request of the driver input.

According to another aspect of the present disclosure, a non-transitory computer readable storage medium storing a presentation control program that is used in a subject vehicle capable of traveling by an automated driving function and controls presentation of information related to the automated driving function is provided. The presentation control program causing at least one processing section to execute a process includes: grasping whether autonomous traveling control, in which a driver of the subject vehicle is not obliged to monitor periphery, is being executed by the automated driving function; notifying, when the subject vehicle that has been traveling by the autonomous traveling control stops, traveling resumption information related to resumption of the traveling of the subject vehicle; grasping, when the subject vehicle stops, a magnitude of acceleration in a deceleration direction occurring in the subject vehicle; and making, when the acceleration exceeds a notification threshold, a notification of the traveling resumption information, and omitting, when the acceleration is less than the notification threshold, the notification of the traveling resumption information.

Hereinafter, a plurality of embodiments will be described with reference to the drawings. Note that the same reference numerals are given to corresponding components in the respective embodiments, whereby redundant description may be omitted. When only a part of a configuration is described in each embodiment, the configurations of other embodiments previously described can be applied to the other parts of the configuration. In addition, not only a combination of configurations explicitly specified in the description of each embodiment but also configurations of a plurality of embodiments can be partially combined even if not explicitly specified as long as there is no problem in the combination.

### First Embodiment

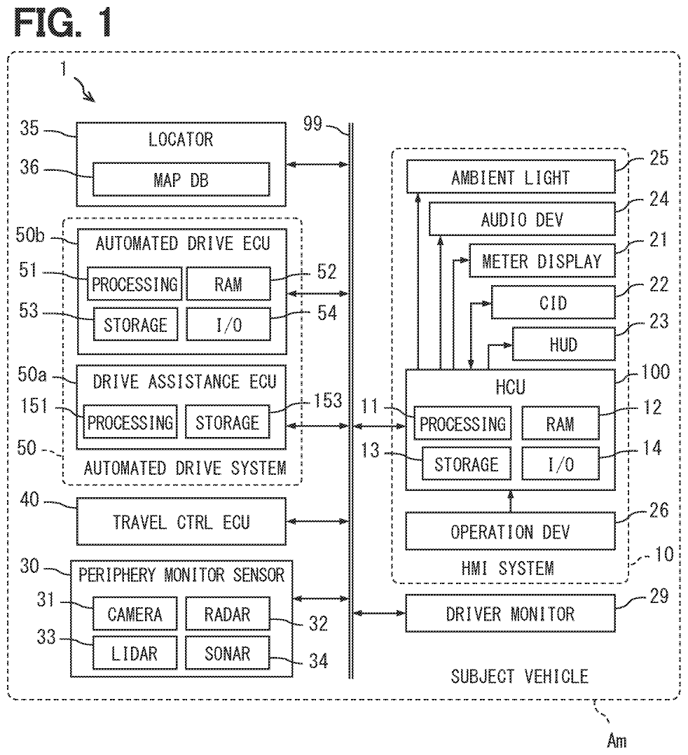

A human machine interface control unit (HCU) according to a first embodiment of the present disclosure, illustrated in FIG. 1 to FIG. 3, is an interface control device used in a vehicle (hereinafter, subject vehicle Am). An HCU 100 constitutes a human machine Interface (HMI) system 10 of the subject vehicle Am together with a plurality of input/output devices and the like. The HMI system 10 has an input interface function of receiving an operation by an occupant, such as a driver of the subject vehicle Am, and an output interface function of presenting information to the driver.

The HCU 100 is communicably connected to a communication bus 99 of an in-vehicle network 1 mounted on the subject vehicle Am. The HCU 100 is one of a plurality of nodes provided in the in-vehicle network 1. A driver monitor 29, a periphery monitoring sensor 30, a locator 35, a traveling control electronic control unit (ECU) 40, a driving assistance ECU 50a, an automated driving ECU 50b, and the like are connected to the communication bus 99 of the in-vehicle network 1. These nodes connected to the communication bus 99 can communicate with each other. Among these devices, the ECUs, and the like, specific nodes may be directly electrically connected to each other, so that they can communicate with each other without going through the communication bus 99.

The driver monitor 29 includes a near-infrared light source, a near-infrared camera, and a control unit that controls them. The driver monitor 29 is installed on, for example, the upper surface of a steering column portion or the upper surface of an instrument panel in a posture in which the near-infrared camera faces a headrest portion of a driver's seat. The driver monitor 29 photographs, with the near-infrared camera, the head of the driver that is irradiated with near-infrared light by the near-infrared light source. An image captured by the near-infrared camera is subjected to image analysis by the control unit. The control unit extracts, from the captured image, information on the face orientation, position of the eye point, line-of-sight direction, and the like of the driver. The driver monitor 29 provides the HCU 100 and the like with the face orientation information, the eye point position information, the line-of-sight direction information, and the like extracted by the control unit as driver status information.

The periphery monitoring sensor 30 is an autonomous sensor that monitors the peripheral environment of the subject vehicle Am. The periphery monitoring sensor 30 includes, for example, one or more of a camera unit 31, a millimeter-wave radar 32, a lidar 33, and a sonar 34. The periphery monitoring sensor 30 can detect a moving object and a stationary object from a detection range around the subject vehicle. The periphery monitoring sensor 30 provides detection information on an object around the subject vehicle to the driving assistance ECU 50a, the automated driving ECU 50b, and the like.

The locator 35 includes a global navigation satellite system (GNSS) receiver, an inertial sensor, and the like. The locator 35 further includes a map database 36 storing three-dimensional map data and two-dimensional map data. The locator 35 reads map data around the current position from the map database 36, and provides the driving assistance ECU 50a, the automated driving ECU 50b, and the like with the map data as locator information together with the position information and direction information on the subject vehicle Am.

The traveling control ECU 40 is an electronic control device mainly including a microcontroller. The traveling control ECU 40 has at least functions of a brake control ECU, a drive control ECU, and a steering control ECU. The traveling control ECU 40 continuously executes the braking force control of each wheel, the output control of an in-vehicle power source, and steering angle control on the basis of any one of an operation command based on a driving operation by the driver, a control command by the driving assistance ECU 50a, and a control command by the automated driving ECU 50b.

The driving assistance ECU 50a and the automated driving ECU 50b constitute an automated driving system 50 of the subject vehicle Am. With the automated driving system 50 mounted, the subject vehicle Am serves as an automated driving vehicle provided with an automated driving function, and can travel by the automated driving function.

The driving assistance ECU 50a realizes a driving assistance function for assisting a driving operation by the driver in the automated driving system 50. The driving assistance ECU 50a enables advanced driving assistance at about level 2 or partial automated driving among the automated driving levels defined by the American Society of Automotive Engineers. The automated driving executed by the driving assistance ECU 50a becomes automated driving with obligation to monitor the periphery in which visual monitoring of the periphery of the subject vehicle by the driver is required.

The automated driving ECU 50b is capable of substituting for driving operations by the driver, and is capable of executing the autonomous traveling at level 3 or higher, in which the system serves as a control subject, among the automated driving levels defined by the American Society of Automotive Engineers. The automated driving executed by the automated driving ECU 50b becomes eyes-off automated driving in which the monitoring of the periphery of the subject vehicle is not required, that is, the periphery monitoring is not obliged.

In the automated driving system 50 described above, the traveling control state of the automated driving function is switched among a plurality of control including at least driving assistance control with obligation to monitor the periphery by the driving assistance ECU 50a and autonomous traveling control without obligation to monitor the periphery by the automated driving ECU 50b. In the following description, the automated drive control at level 2 or lower by the driving assistance ECU 50a will be referred to as “driving assistance control”, and the automated drive control at level 3 or higher by the automated driving ECU 50b will be referred to as “autonomous traveling control”.

In an automated driving period during which the subject vehicle Am travels by the autonomous traveling control, the driver can be permitted to perform a specific action (hereinafter, a second task) other than predefined operations. The second task is legally permitted to the driver until an execution request for a driving operation performed by the automated driving ECU 50b and the HCU 100 in cooperation, that is, a request for a driving change, occurs. For example, watching of entertainment contents such as a video content, operation of a device such as a smartphone, and an action such as eating, are assumed as the second task.

The driving assistance ECU 50a is a computer mainly including a control circuit provided with a processing section 151, a RAM, a storage section 153, an input/output interface, a bus connecting them, and the like. The driving assistance ECU 50a realizes driving assistance functions, such as adaptive cruise control (ACC) and lane trace control (LTC), by executing programs by the processing section 151. The driving assistance ECU 50a executes driving assistance control for causing the subject vehicle Am to travel along a subject vehicle lane on which the subject vehicle Am is traveling by cooperation of the functions of the ACC and the LTC. In addition, the driving assistance ECU 50a provides control status information, indicating a state of the driving assistance control, to the automated driving ECU 50b.

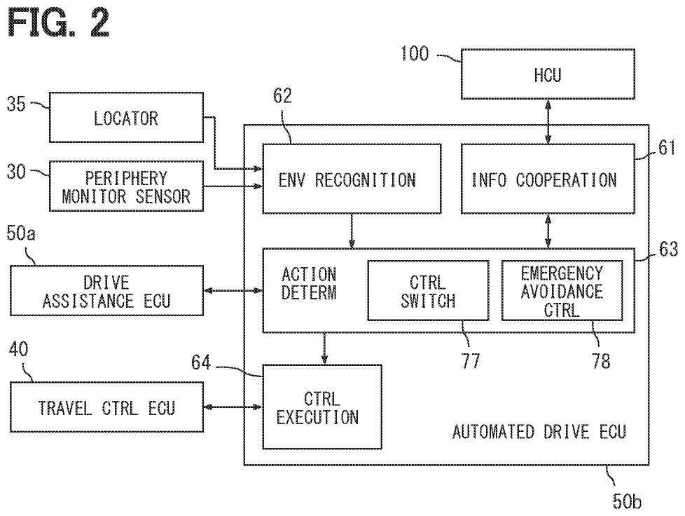

The automated driving ECU 50b has higher calculation capability than the driving assistance ECU 50a, and can execute at least traveling control corresponding to the ACC and the LTC. The automated driving ECU 50b may be capable of executing driving assistance control in which the driver is obliged to monitor the periphery, instead of the driving assistance ECU 50a, in a scene or the like where the autonomous traveling control is temporarily interrupted. The automated driving ECU 50b is a computer mainly including a control circuit provided with a processing section 51, a RAM 52, a storage section 53, an input/output interface 54, a bus connecting them, and the like. The processing section 51 executes various processing to realize an automated drive control method of the present disclosure by accessing the RAM 52. The storage section 53 stores various programs (automated drive control programs and the like) to be executed by the processing section 51. With the programs executed by the processing section 51, an information cooperation section 61, an environment recognition section 62, an action determination section 63, a control execution section 64, and the like are constructed as a plurality of functional sections for realizing the automated driving function in the automated driving ECU 50b (see FIG. 2).

The information cooperation section 61 provides information to an information cooperation section 82 of the HCU 100 and acquires information from the information cooperation section 82. Through the cooperation of these information cooperation sections 61 and 82, the automated driving ECU 50b and the HCU 100 share the information acquired by each of them. The information cooperation section 61 generates control status information indicating an operating state of the automated driving function, and provides the generated control status information to the information cooperation section 82. In addition, the information cooperation section 61 enables notification by the HCU 100 synchronized with the operating state of the automated driving function by outputting an execution request for notification to the information cooperation section 82. On the other hand, the information cooperation section 61 acquires operation information, action information, and the like on the driver, which will be described later, from the information cooperation section 82. Based on the operation information, the information cooperation section 61 grasps a user operation to be input to the HMI system 10 and the like. Furthermore, based on the action information, the information cooperation section 61 grasps whether periphery monitoring by the driver is being executed. Note that the information cooperation section 61 may acquire the driver status information from the driver monitor 29 to grasp whether the periphery monitoring by the driver is being executed.

The environment recognition section 62 combines the locator information acquired from the locator 35 and the detection information acquired from the periphery monitoring sensor 30 to recognize the traveling environment of the subject vehicle Am. Specifically, the environment recognition section 62 grasps information on a road on which the subject vehicle Am travels, a relative position and a relative speed with a dynamic target (another vehicle or the like) around the subject vehicle, and the like. In addition, the environment recognition section 62 acquires vehicle information, indicating a state of the subject vehicle Am, from the communication bus 99. As an example, the environment recognition section 62 acquires vehicle speed information indicating the current traveling speed of the subject vehicle Am.

The environment recognition section 62 combines information on another vehicle around the subject vehicle with the vehicle speed information and the like to grasp the congestion around the subject vehicle Am. When the current traveling speed of the subject vehicle Am is equal to or lower than a congestion speed (e.g., about 30 km/h) and there are both a preceding vehicle and a following vehicle that are traveling in the subject vehicle lane, the environment recognition section 62 determines that the periphery of the subject vehicle is in a congestion state.

The environment recognition section 62 determines whether the road on which the subject vehicle Am is traveling or the road on which the subject vehicle Am is scheduled to travel is a preset automated driving available area (hereinafter, an AD area) or a restricted AD area. Information, indicating whether it is the AD area and the restricted AD area, may be recorded in the map data stored in the map database 36, or may be included in reception information received by an in-vehicle communication device.

The AD area and the restricted AD area can correspond to an operational design domain in which automated driving without obligation to monitor periphery by a driver is legally permitted. The automated driving without obligation to monitor periphery includes, as a plurality of control modes, congestion limited control (hereinafter, congestion level 3) executed only in traveling in congestion and area limited control (hereinafter, area level 3) executed only in a specific area (AD area). Both the congestion level 3 and the area level 3 are permitted to be executed on a road in the AD area, and only the congestion level 3 is permitted to be executed on a road in the restricted AD area. In a manual driving area (hereinafter, MD area) that is included in neither the AD area nor the restricted AD area, traveling by the autonomous traveling control at level 3 is prohibited in principle. In the MD area, traveling by the automated driving at level 2 or higher may be prohibited. The AD area or the restricted AD area is set, for example, on an expressway or an automobile exclusive road. Furthermore, a specific general road, the road environment of which has been improved such that automated driving without obligation to monitor periphery can be executed, may be set as the AD area or the restricted AD area.

The action determination section 63 cooperates with the driving assistance ECU 50a and the HCU 100 to control a driving change between the automated driving system 50 and the driver. When the automated driving system 50 has the control right over the driving operation, the action determination section 63 generates a scheduled traveling line on which the subject vehicle Am will be caused to travel on the basis of a recognition result of the traveling environment by the environment recognition section 62, and outputs the generated scheduled traveling line to the control execution section 64. The action determination section 63 includes a control switching section 77 and an emergency avoidance control section 78 as sub-functional sections for controlling the operating state of the automated driving function.

The control switching section 77 cooperates with the driving assistance ECU 50a to control the start and termination of the driving assistance control with obligation to monitor the periphery by the driver. In addition, the control switching section 77 cooperates with the driving assistance ECU 50a to switch between the driving assistance control with obligation to monitor the periphery by the driver and the autonomous traveling control without obligation to monitor the periphery by the driver. In detail, a plurality of transition conditions (hereinafter, level 3 starting conditions) for permitting a transition to the autonomous traveling control are set in the control switching section 77. The level 3 starting conditions include a requirement related to the driver of the subject vehicle Am, a requirement related to the traveling state of the subject vehicle Am, a requirement related to the traveling environment around the subject vehicle, and the like. For example, traveling in the AD area and grasping the congestion around the subject vehicle are set as the level 3 starting conditions. Based on the satisfaction of some or all of the plurality of the level 3 starting conditions, the control switching section 77 permits the transition from the driving assistance control to the autonomous traveling control. Furthermore, when the subject vehicle Am is caused to travel by the autonomous traveling control, the control switching section 77 switches the control mode of the autonomous traveling control among a plurality of control modes including the congestion level 3 and the area level 3.

When predicting collision with an object present in front of the vehicle, the emergency avoidance control section 78 automatically executes at least braking control. That is, the emergency avoidance control section 78 is a functional section that realizes an automatic emergency braking (AEB) function. As an example, the emergency avoidance control section 78 starts emergency braking when a time-to-collision (TTC) becomes equal to or less than a predetermined time. The braking control by the emergency avoidance control section 78 is preferentially executed over the driving assistance control by the driving assistance ECU 50a and the autonomous traveling control by the control switching section 77. Note that the function of the emergency avoidance control section 78 may be implemented in the driving assistance ECU 50a.

When the automated driving ECU 50b has the control right over the driving operation, the control execution section 64 cooperates with the traveling control ECU 40 to execute acceleration/deceleration control, steering control, and the like of the subject vehicle Am in accordance with the scheduled traveling line generated by the action determination section 63. Specifically, the control execution section 64 generates a control command based on the scheduled traveling line, and sequentially outputs the generated control command to the traveling control ECU 40.

Next, details of each of a plurality of display devices, an audio device 24, an ambient light 25, an operation device 26, and the HCU 100, which are included in the HMI system 10, will be sequentially described.

The display devices present information through the vision of the driver by image display or the like. The display devices include a meter display 21, a center information display (hereinafter, CID) 22, a head-up display (hereinafter, HUD) 23, and the like. The CID 22 has a touch panel function, and detects a touch operation on a display screen by the driver or the like.

The audio device 24 includes a plurality of speakers installed in the vehicle interior in an arrangement surrounding the driver's seat, and reproduces a notification sound, a voice message, or the like in the vehicle interior by the speakers. The ambient light 25 is provided on each of an instrument panel, a steering wheel, and the like. The ambient light 25 performs information presentation using the peripheral field of view of the driver by ambient display that changes light emission color.

The operation device 26 is an input section that receives a user operation by the driver or the like (hereinafter, a driver operation). For example, the driver operation related to the operation and stop of the automated driving function is input to the operation device 26. As an example, the driver operation (hereinafter, level 2 transition operation) for commanding the start of the driving assistance control or the driver operation (hereinafter, level 3 transition operation) for commanding a transition from the driving assistance control to the autonomous traveling control is input to the operation device 26. The operation device 26 includes a steering switch provided on a spoke portion of the steering wheel, an operation lever provided on a steering column portion, a voice input device that recognizes utterance contents of the driver, and the like.

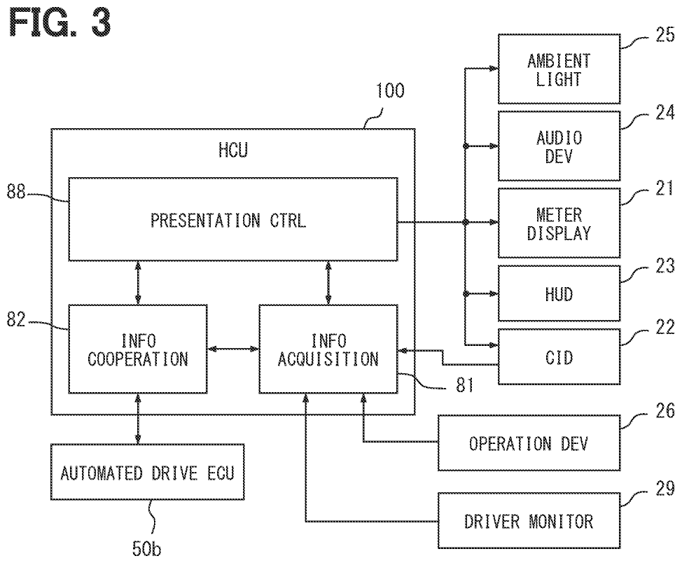

The HCU 100 is an information presentation device that integrally controls information presentation using the plurality of display devices, the audio device 24, and the ambient light 25. The HCU 100 cooperates with the automated driving system 50 to control presentation of information related to the automated driving. The HCU 100 is a computer mainly including a control circuit provided with a processing section 11, a RAM 12, a storage section 13, an input/output interface 14, a bus connecting them, and the like. The processing section 11 accesses the RAM 12 to execute various processing for a presentation control process. The RAM 12 may include a video RAM for generating video data. The storage section 13 includes a non-volatile storage medium. The storage section 13 stores various programs (a presentation control program, etc.) to be executed by the processing section 11. The HCU 100 constructs a plurality of functional sections by executing the programs stored in the storage section 13 by the processing section 11. In the HCU 100, functional sections, such as an information acquisition section 81, the information cooperation section 82, and a presentation control section 88, are constructed (see FIG. 3).

The information acquisition section 81 acquires vehicle information (e.g., vehicle speed information or the like) indicating the state of the subject vehicle Am from the communication bus 99. Based on the vehicle speed information, the information acquisition section 81 grasps whether the subject vehicle Am is being stopped. In addition, the information acquisition section 81 acquires operation information indicating the content of the driver operation from the CID 22, the operation device 26, and the like. Furthermore, the information acquisition section 81 acquires the driver status information from the driver monitor 29. Based on the driver status information, the information acquisition section 81 continuously grasps whether the periphery monitoring by the driver is being executed.

The information cooperation section 82 cooperates with the automated driving ECU 50b to enable information to be shared between the automated driving system 50 and the HCU 100. The information cooperation section 82 provides, to the automated driving ECU 50b, the operation information grasped by the information acquisition section 81 and the action information indicating whether the periphery monitoring is being executed. In addition, the information cooperation section 82 acquires, from the automated driving ECU 50b, an execution request for the information presentation related to the automated driving function and the control status information indicating the state of the automated driving function.

Based on the control status information, the information cooperation section 82 grasps the operating state of the automated driving by the automated driving system 50. Specifically, the information cooperation section 82 grasps whether the traveling control that is being executed is the driving assistance control or the autonomous traveling control, that is, whether the autonomous traveling control in which the driver is not obliged to monitor the periphery is being executed by the automated driving function. When the subject vehicle Am is traveling in a state in which the driver is not obliged to monitor the periphery, the information cooperation section 82 further grasps the control mode of the autonomous traveling control.

When the automated driving system 50 causes the subject vehicle Am to travel by the driving assistance control or the autonomous traveling control, the information cooperation section 82 grasps the stop of the subject vehicle Am on the basis of the control status information. The information cooperation section 82 may grasp the stop of the subject vehicle Am with reference to a result of stop determination based on the vehicle speed information by the information acquisition section 81. When having grasped the stop of the subject vehicle Am, the information cooperation section 82 further grasps the reason for the current stop of the subject vehicle Am on the basis of the control status information. The reason for the stop is: that the subject vehicle Am that has been traveling in congestion by follow-up traveling stops following the preceding vehicle; that the subject vehicle Am stops by the activation of the AEB associated with the emergency avoidance control by the emergency avoidance control section 78; or the like.

The presentation control section 88 integrally executes provision of information to the driver using the respective display devices, the audio device 24, and the ambient light 25 (hereinafter, information presentation devices). Based on the control status information and the execution request acquired by the information cooperation section 82, the presentation control section 88 executes content provision and information presentation in accordance with the operation state of the automated driving. When the execution of eyes-off autonomous traveling control is grasped by the information cooperation section 82, the presentation control section 88 enables reproduction of a video content or the like. In addition, the presentation control section 88 makes, to the driver, a request for the driving change or the like on the basis of the execution request acquired by the information cooperation section 82.

When the stop of the subject vehicle Am that has been traveling by the driving assistance control or the autonomous traveling control is grasped by the information cooperation section 82, the presentation control section 88 notifies traveling resumption information related to resumption of the traveling of the subject vehicle Am using the information presentation devices. The presentation control section 88 changes the content of the traveling resumption information in response to the reason for the stop of the subject vehicle Am grasped by the information cooperation section 82.

In detail, when the subject vehicle Am automatically stops, the control at the time of restarting (hereinafter, restarting control) to resume the traveling of the subject vehicle Am varies depending on the content of the traveling control executed before the stop. In addition, different restarting control is executed depending on whether the reason for the stop of the subject vehicle Am is due to the emergency avoidance control or the normal stop in congestion. By presenting the traveling resumption information having a content corresponding to the traveling control and the reason for the stop, the presentation control section 88 appropriately informs the driver of the content of the restarting control to be changed in response to the traveling control and the reason for the stop.

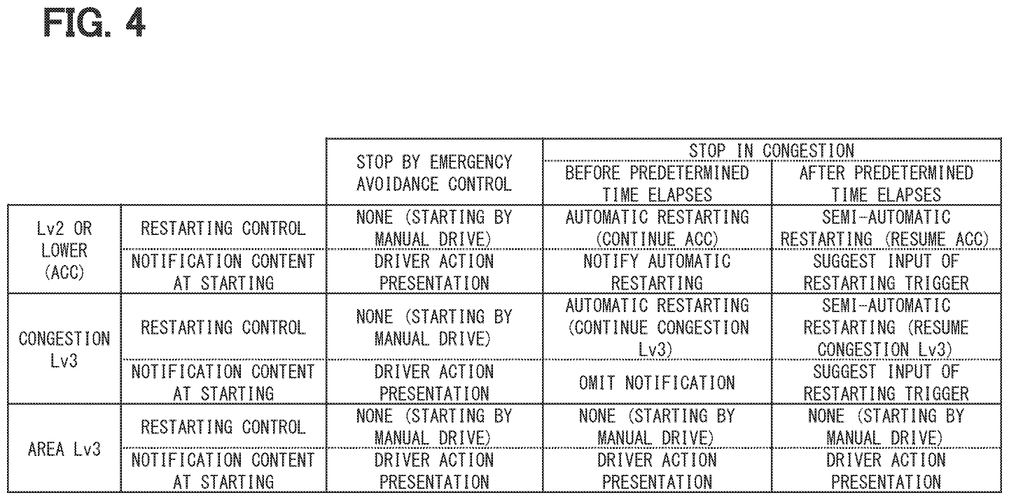

Hereinafter, based on FIG. 4 and with reference to FIG. 1 to FIG. 3, details of the restarting control and the information presentation different depending on the traveling control and the reason for the stop will be described in order by being divided into four scenes.

<1. Scene where Subject Vehicle Stops by Emergency Avoidance Control>

When the subject vehicle Am stops by the activation of the emergency avoidance control (AEB), the driving assistance control and the autonomous traveling control are temporarily terminated. That is, when the subject vehicle Am stops by the activation of the AEB, the traveling control state of the subject vehicle Am is forcibly made a transition to manual driving. Therefore, the driver is required to restart the subject vehicle Am by an accelerator operation. As described above, when the AEB is activated, restarting by manual driving by the driver is required regardless of the traveling control that is being executed at the time of the stop.

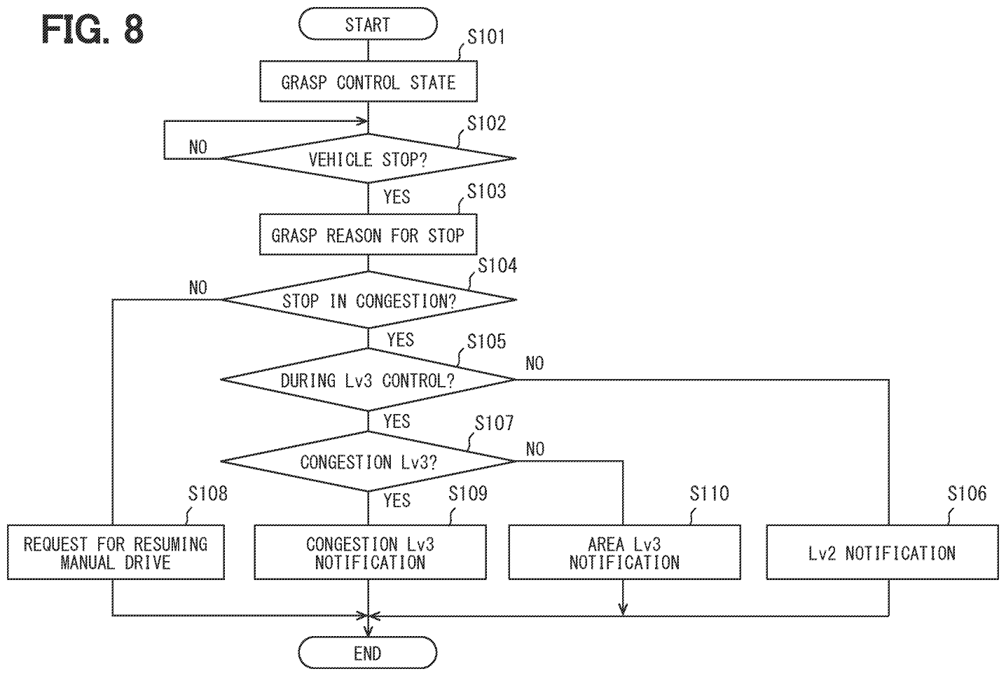

When the reason for the stop is due to stop by the activation of the emergency avoidance control (AEB), the presentation control section 88 shows, in response to the restarting control described above, an action by the driver required for resuming the traveling by manual driving, by notification of the traveling resumption information regardless of the content of the traveling control that is being executed. Specifically, the presentation control section 88 uses the meter display 21 and the HUD 23 to notify that the control state of the subject vehicle Am has made a transition to manual driving. In addition, the presentation control section 88 sequentially executes notification that urges to check the situation around the subject vehicle and notification that suggests the start of an accelerator operation (see S108 in FIG. 8).

<2. Scene where Subject Vehicle Stops Due to Congestion Under Driving Assistance Control>

When the subject vehicle Am that has been traveling by the driving assistance control (ACC function) at the automated driving level 2 or lower stops in congestion, the driving assistance ECU 50a causes the operation of the driving assistance control to be continued. When an elapsed time after the stop does not exceed a predetermined time (e.g., 30 seconds), the ACC function automatically restarts the subject vehicle Am so as to follow the restarted preceding vehicle without requiring an input of an operation (hereinafter, restarting trigger) by the driver. On the other hand, when the elapsed time after the stop has exceeded the predetermined time, the ACC function restarts the subject vehicle Am on the basis of the input of the restarting trigger by the driver, and resumes the follow-up traveling. The restarting trigger is set to include, for example, a bush operation on a steering switch (resume button, set button, or the like) and an operation of temporarily stepping on the accelerator pedal. The driver operation corresponding to such a restarting trigger may be appropriately changed.

When the reason for the stop is due to stop in congestion and the elapsed time after the stop is within the predetermined time, the presentation control section 88 notifies, in response to the restarting control described above, that automatic restarting by the ACC function will be executed, as the traveling resumption information. The notification of the traveling resumption information in this case is set to be information presentation in which a content with reduced attractiveness, such as an icon or a text message, is displayed by the meter display 21 or the HUD 23. When automatic restarting by the ACC function is performed, the presentation control section 88 may omit the notification of the traveling resumption information.

On the other hand, when the reason for the stop is due to stop in congestion and the elapsed time after the stop has exceeded the predetermined time, the presentation control section 88 executes notification that suggests or urges an input of the restarting trigger. The notification that urges an input of the restarting trigger corresponds to the notification of the traveling resumption information indicating an action by the driver required for the restarting. In this case, the presentation control section 88 causes the meter display 21, the HUD 23, or the like to display a content suggesting an input of the restarting trigger (see S106 in FIG. 8).

<3. Scene where Subject Vehicle Stops Due to Congestion Under Control by Congestion Level 3>

When the subject vehicle Am that has been traveling by the autonomous traveling control at automated driving level 3 or higher stops in congestion, the automated driving ECU 50b changes the content of the restarting control depending on the control mode of the autonomous traveling control that is being executed. When the subject vehicle Am that has been traveling by the autonomous traveling control by the congestion level 3 stops in congestion, the automated driving ECU 50b causes the operation of the congestion level 3 to be continued. When the elapsed time after the stop does not exceed a predetermined time (e.g., 30 seconds), the automated driving ECU 50b does not require an input of the restarting trigger by the driver, similarly to the ACC function of the driving assistance ECU 50a. The automated driving ECU 50b automatically restarts the subject vehicle Am so as to follow the restarted preceding vehicle. On the other hand, when the elapsed time after the stop has exceeded the predetermined time, the automated driving ECU 50b restarts the subject vehicle Am on the basis of the input of the restarting trigger by the driver, and resumes the follow-up traveling. The restarting trigger for resuming the autonomous traveling control may also be the same as the restarting trigger for resuming the driving assistance control.

When the reason for the stop is due to stop in congestion and the elapsed time after the stop is within the predetermined time, the presentation control section 88 notifies, in response to the restarting control described above, that automatic restarting is executed by continuation of the operation of the congestion level 3, as the traveling resumption information. Even in this case, an icon, a text message, or the like for notifying automatic restarting is displayed by the meter display 21 or the HUD 23. On the other hand, when the reason for the stop is due to stop in congestion and the elapsed time after the stop has exceeded the predetermined time, the presentation control section 88 causes the meter display 21, the HUD 23, or the like to display a content that suggests or urges an input of the restarting trigger.

Note that the driving assistance ECU 50a and the automated driving ECU 50b can change the predetermined time, by which the necessity of the restarting trigger is changed, depending on the type of a road on which the subject vehicle Am travels. As an example, when the subject vehicle Am is traveling on an expressway and an automobile exclusive road, the predetermined time is set to about 30 seconds as described above. On the other hand, when the subject vehicle Am is traveling on a general road, the predetermined time is set to about 3 seconds. As described above, the predetermined time, in the case of traveling on an expressway and an automobile exclusive road, is set to be longer than the predetermined time in the case of traveling on a general road (see S109 in FIG. 8).

<4. Scene where Subject Vehicle Stops Due to Congestion Under Control by Area Level 3>

When the subject vehicle Am that has been traveling by the autonomous traveling control by the area level 3 stops in congestion, the automated driving ECU 50b causes the operation of the area level 3 to be stopped. In a scene where the area level 3 operates, the traveling speeds of the subject vehicle Am and other vehicles around the subject vehicle tend to be higher than in a scene where the congestion level 3 operates. Therefore, when the subject vehicle Am stops during the execution of the area level 3, the automated driving ECU 50b terminates the area level 3 and switches the traveling control state of the subject vehicle Am to manual driving. With the switching from the area level 3 to manual driving, the driver is required to operate the accelerator to restart the subject vehicle Am.

When the subject vehicle Am stops under the control by the area level 3, the presentation control section 88 shows, in response to the restarting control described above, an action by the driver required for resuming the traveling by manual driving, by notifying the traveling resumption information. Even in this case, the presentation control section 88 notifies that the control state of the subject vehicle Am has made a transition to manual driving, and sequentially executes notification that urges to check the situation around the subject vehicle and notification that suggests the start of an accelerator operation (see S110 in FIG. 8).

Note that, when the congestion around the subject vehicle is grasped, the control switching section 77 normally switches the control mode from the area level 3 to the congestion level 3. Therefore, the scene, where the subject vehicle stops in congestion while the area level 3 is continued, is limited to, for example, a rare case where the control transition to the congestion level 3 cannot be made in time due to occurrence of sudden congestion.

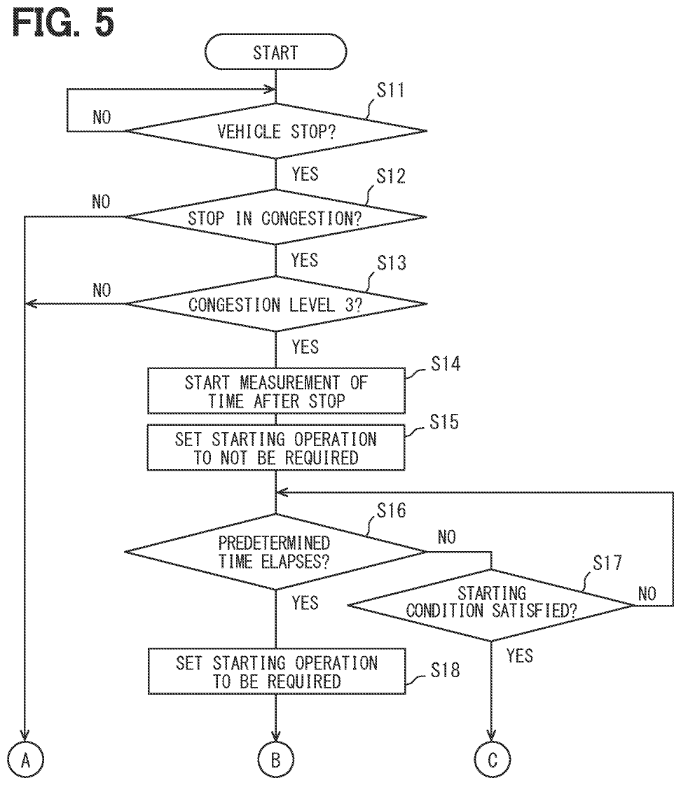

Next, details of each of the starting control process for realizing the restarting control described so far and a notification control process for realizing the notification of the traveling resumption information will be described below on the basis of FIG. 5 to FIG. 8 and with reference to FIG. 1 to FIG. 4.

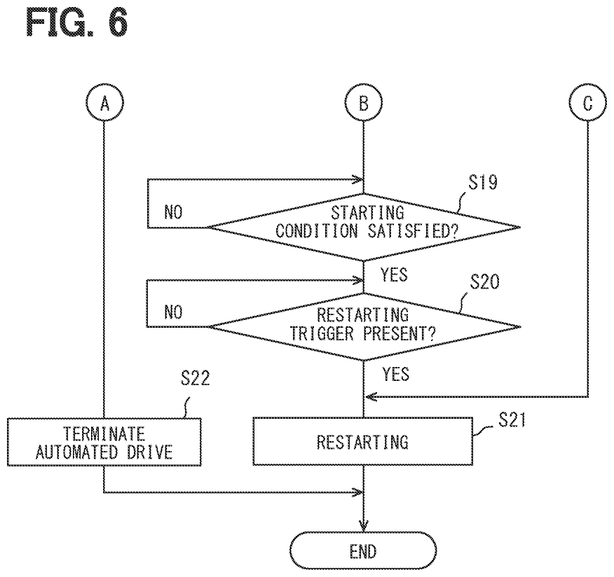

The starting control process illustrated in FIG. 5 and FIG. 6 is started by the automated driving ECU 50b on the basis of completion of the transition to the autonomous traveling control, and is continuously executed until the autonomous traveling control is terminated.

In S11, the environment recognition section 62 determines whether the subject vehicle Am that has been traveling by the autonomous traveling control stops. When the subject vehicle Am does not stop, the determination in S11 is repeated. When it is determined in S11 that the subject vehicle Am stops, the process proceeds to S12.

In S12, the action determination section 63 grasps the reason for the current stop of the subject vehicle Am. When it is determined in S12 that the current stop of the subject vehicle Am is not stop in congestion but stop resulting from the emergency avoidance control, the process proceeds to S22, where the autonomous traveling control (automated driving) that is being executed is terminated. On the other hand, when it is determined in S12 that the reason for the current stop of the subject vehicle Am is stop in congestion, the process proceeds to S13.

In S13, the action determination section 63 determines the control mode of the autonomous traveling control that is being executed. When the area level 3 is being executed, the process proceeds to S22, where the automated driving by the area level 3 that is being executed is terminated. On the other hand, when the congestion level 3 is being executed, the process proceeds to S14. In S14, measurement of the elapsed time after the stop of the subject vehicle Am that has stopped in congestion is started, and the process proceeds to S15. In S15, it is set to a state in which an operation for restarting (restarting trigger) is not required, and the process proceeds to S16.

In S16, the environment recognition section 62 determines whether the elapsed time after the stop has exceeded the predetermined time. When it is determined in S16 that it is before the predetermined time elapses, the process proceeds to S17. In S17, it is determined whether the starting condition for the subject vehicle Am is satisfied. For example, the fact that a predetermined time (several seconds) has elapsed since the start of the preceding vehicle is set as the starting condition. When it is determined in S17 that the starting condition is satisfied, the process proceeds to S21, where the subject vehicle Am is automatically restarted while the autonomous traveling control by the congestion level 3 is continued. On the other hand, when it is determined in S17 that the starting condition is not satisfied, the process returns to S16.

When it is determined in S16 that the elapsed time after the stop has exceeded the predetermined time, the process proceeds to S18. In S18, it is set to a state in which the restarting trigger for restarting is required, and the process proceeds to S19. In S19, it is determined whether the starting condition for the subject vehicle Am is satisfied, similarly to S17. When it is determined in S19 that the starting condition for the subject vehicle Am is satisfied, the process proceeds to S20.

In S20, the presence or absence of the driver operation to serve as the restarting trigger is determined. The driver operation to serve as the restarting trigger is, for example, an operation of pressing the operation device 26 or an operation of temporarily stepping on the accelerator pedal. When it is determined in S20 that there is an input of the driver operation to serve as the restarting trigger, the process proceeds to S21, where the subject vehicle Am is automatically restarted while the autonomous traveling control by the congestion level 3 is continued.

According to the starting control process described above, when the elapsed time does not exceed the predetermined time in the scene where the subject vehicle Am stops during the execution of the congestion level 3 due to congestion, an input by the driver is not required for restarting the subject vehicle Am. On the other hand, when the elapsed time after the stop has exceeded the predetermined time, the subject vehicle Am restarts based on an input by the driver, and resumes the traveling by the congestion level 3.

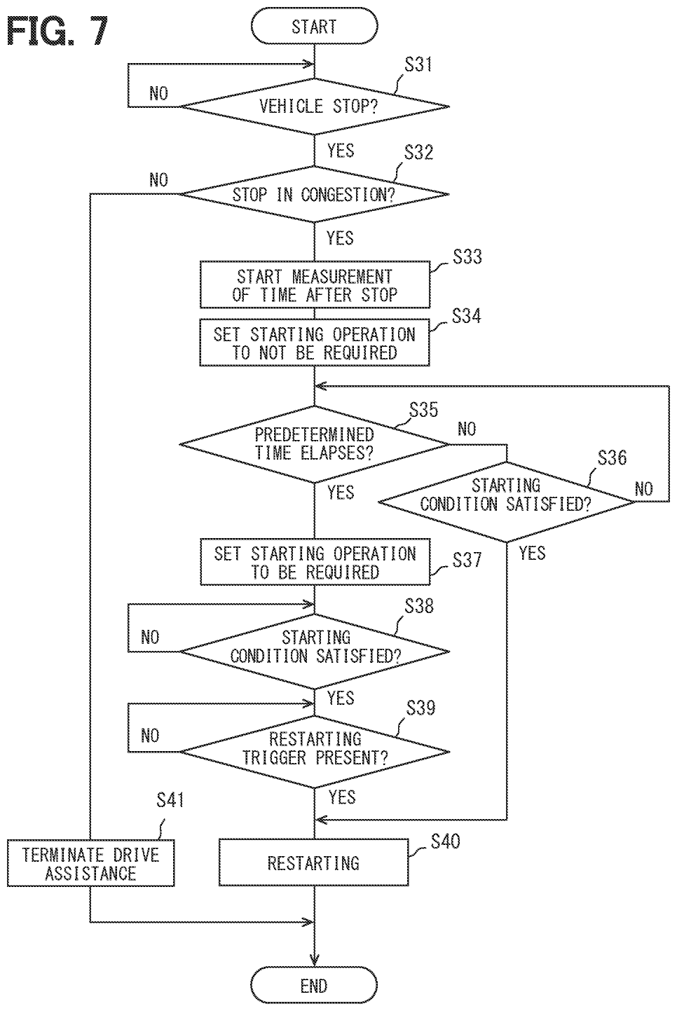

The starting control process illustrated in FIG. 7 is started by the driving assistance ECU 50a on the basis of the activation of the driving assistance control, and is continuously executed until the driving assistance control is terminated. The respective processing of S31 to S41 in the starting control process executed by the driving assistance ECU 50a are substantially the same as those of S11, S12, and S14 to S22 (see FIG. 5) in the starting control process executed by the automated driving ECU 50b.

According to the starting control process described above, when the elapsed time does not exceed the predetermined time in the scene where the subject vehicle Am stops during the execution of the driving assistance control due to congestion, an input by the driver is not required for restarting the subject vehicle Am. On the other hand, when the elapsed time after the stop has exceeded the predetermined time, the subject vehicle Am restarts based on an input by the driver, and resumes the traveling by the driving assistance control.

The notification control process illustrated in FIG. 8 is started by the HCU 100 on the basis of the start of the driving assistance control or the autonomous traveling control by the automated driving system 50. The notification control process is repeatedly started until the driving assistance control or the autonomous traveling control is terminated.

In S101, the information cooperation section 82 grasps the control state of the traveling control executed by the automated driving system 50, and the process proceeds to S102. In S101, it is grasped whether the autonomous traveling control in which the driver is not obliged to monitor the periphery is being executed by the automated driving ECU 50b and whether the driving assistance control in which the driver is obliged to monitor the periphery is being executed by the driving assistance ECU 50a. When the autonomous traveling control is being executed by the automated driving ECU 50b, the control mode that is being executed is further grasped in S101.

In S102, the information acquisition section 81 or the information cooperation section 82 determines whether the subject vehicle Am has stopped. When it is determined in S102 that the subject vehicle Am has stopped, the process proceeds to S103. In S103, the information cooperation section 82 grasps the reason for the current stop of the subject vehicle Am, and the process proceeds to S104.

In S104, the information cooperation section 82 determines whether the reason for the current stop grasped in S103 is due to stop in congestion. When it is determined in S104 that the current stop of the subject vehicle Am is stop resulting from the emergency avoidance control, the process proceeds to S108. In S108, the content that requests the driver to resume the traveling by manual driving is notified as the traveling resumption information, and the current notification control process is terminated.

On the other hand, when it is determined in S104 that the current stop of the subject vehicle Am is stop in congestion, the process proceeds to S105. In S105, it is determined whether the autonomous traveling control at level 3 is being executed. When it is determined in S105 that the subject vehicle Am that has been traveling by the driving assistance control at level 2 or lower stops, the process proceeds to S106. In S106, the traveling resumption information corresponding to the driving assistance control at level 2 is notified, and the current notification control process is terminated. In S106, it is notified as the traveling resumption information that the automatic restarting by the ACC function will be executed or that the restarting trigger is required for resuming the traveling by the ACC function.

When it is determined in S105 that the subject vehicle Am that has been traveling by the autonomous traveling control stops, the process proceeds to S107. In S107, it is determined whether the control mode that is being executed is the congestion level 3. When it is determined in S107 that the subject vehicle Am that has been traveling by the congestion level 3 stops, the process proceeds to S109. In S109, the traveling resumption information corresponding to the congestion level 3 is notified, and the current notification control process is terminated. In S109, it is notified as the traveling resumption information that the automatic restarting by the autonomous traveling control will be executed or that the restarting trigger is required for resuming the operation of the congestion level 3.

On the other hand, when it is determined in S107 that the subject vehicle Am that has been traveling by the area level 3 stops, the process proceeds to S110. In S110, the traveling resumption information corresponding to the area level 3 is notified, and the current notification control process is terminated. In S110, information presentation that requests the driver to resume the traveling by manual driving is executed as the notification of the traveling resumption information.

The notification control process described above may be mainly executed by the automated driving ECU 50b. That is, a timing at which the notification is executed may be determined by the automated driving ECU 50b, and the HCU 100 may only execute each notification and request on the basis of the execution request provided from the information cooperation section 61.

In the first embodiment described so far, when the subject vehicle Am that has been traveling by the autonomous traveling control stops, the traveling resumption information related to the resumption of the traveling of the subject vehicle Am is notified. Therefore, even if the driver cannot grasp the situation around the subject vehicle, the driver can know an action after the stop from the traveling resumption information. As a result, the convenience of the automated driving without obligation to monitor the periphery can be ensured.

In addition, when the subject vehicle Am stops in the first embodiment, the reason for the stop is grasped. Then, the presentation control section 88 changes the content of the traveling resumption information depending on the reason for the stop. Therefore, even if the restarting control corresponding to the reason for the stop is executed by the automated driving ECU 50b, the presentation control section 88 can provide the traveling resumption information, having a content corresponding to the current restarting control, to the driver. According to the above, the driver can appropriately grasp the control content of the automated driving. Therefore, the convenience of the automated driving is further ensured.

In the first embodiment, when the activation of the AEB is the reason for the stop, the traveling resumption information, indicating the resumption of the traveling by manual driving, is notified. Therefore, under a driving environment so complicated as the AEB is activated, it is possible to smoothly transfer the control right over the driving operation to the driver. On the other hand, when the subject vehicle Am that has been traveling in congestion stops following the preceding vehicle, the traveling resumption information, indicating the resumption of the traveling by the autonomous traveling control, is notified. According to the notification of such information, the driver can relievedly continue using the autonomous traveling control. Therefore, the convenience of the automated driving can be ensured.

Furthermore, when another vehicle interrupts in congestion, it has been difficult for the driver to distinguish whether the current stop of the subject vehicle Am is due to stop in normal congestion or due to stop by the activation of the AEB. Therefore, if the content of the traveling resumption information is changed as described above, the driver can appropriately grasp a situation, in which the subject vehicle Am has stopped, and smoothly start an action for restarting.

In addition, in the first embodiment, the control mode of the autonomous traveling control is switched among a plurality of control modes including the congestion level 3 and the area level 3. The information cooperation section 82 grasps the control mode of the autonomous traveling control executed by the automated driving ECU 50b. Then, when the subject vehicle Am has stopped during the traveling by the congestion level 3, the traveling resumption information, indicating the resumption of the traveling by the congestion level 3, is notified. Therefore, the driver can relievedly continue using the autonomous driving by the congestion level 3.

On the other hand, when the subject vehicle Am has stopped during the traveling by the area level 3, the traveling resumption information, indicating the resumption of the traveling by manual driving, is notified, and thus the driver can smoothly take over the control right over the driving operation. As a result, even in a traveling scene where the traveling speed of another vehicle around the subject vehicle is relatively high, the driver can quickly resume the traveling of the subject vehicle Am by driver's own driving.

The traveling resumption information in the first embodiment includes information indicating an action by the driver required for restarting the subject vehicle Am. Specifically, execution of periphery monitoring, an accelerator operation, an input of the restarting trigger, and the like are indicated by the traveling resumption information. When an action by the driver is required for restarting the subject vehicle Am, the driver is notified of the required action each time, as described above. According to the above, even if an action by the driver is required for resuming the traveling of the subject vehicle Am, the driver can easily grasp the action to take. As a result, convenience for the driver can be ensured.

In the first embodiment, when the subject vehicle Am that has been traveling by the autonomous traveling control by the congestion level 3 without obligation to monitor the periphery stops due to congestion, an input by the driver is not required for resuming the traveling of the subject vehicle Am if the elapsed time after the stop does not exceed the predetermined time. On the other hand, when the elapsed time after the stop has exceeded the predetermined time, the traveling of the subject vehicle Am is resumed based on an input by the driver. According to the above, the situation around the subject vehicle can need to be grasped only in a scene where it is easy to ensure time for grasping the situation around the subject vehicle. Therefore, the driver can grasp an action to take over time. Therefore, the convenience of the automated driving without obligation to monitor the periphery can be ensured.

Furthermore, in the first embodiment, the presentation control section 88 starts, in response to the fact that the driver operation is not required for restarting until the predetermined time elapses from the stop of the subject vehicle Am, the notification of the traveling resumption information after the predetermined time elapses from the stop. According to the above, the notification of the traveling resumption information is started at a timing when an operation by the driver becomes required, and thus it is possible to present information the driver is less likely to feel bothersome. Therefore, the convenience of the automated driving can be more easily ensured.

Note that, in the first embodiment, the environment recognition section 62 corresponds to the “time determination section”, the action determination section 63 corresponds to the “traveling control section”, the information cooperation section 82 corresponds to the “control grasping section”, and the presentation control section 88 corresponds to the “notification control section”. Furthermore, the HCU 100 corresponds to the “presentation control device”, and the automated driving ECU 50b corresponds to the “automated drive control device”.

### Second Embodiment

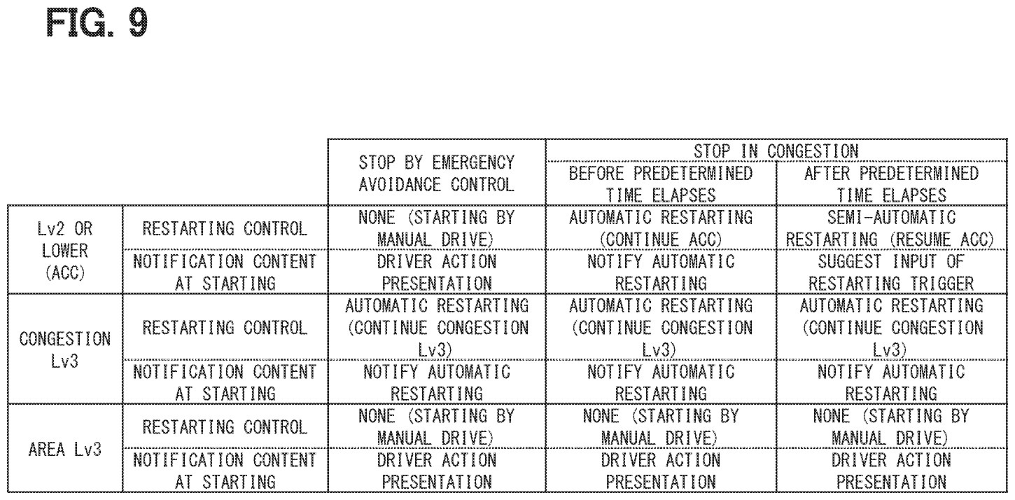

A second embodiment of the present disclosure is a modification of the first embodiment. The second embodiment is different from the first embodiment in restarting control in a case where the congestion level 3 is being executed. Hereinafter, details of restarting control and presentation of traveling resumption information in the second embodiment will be described based on FIG. 9 to FIG. 11 and with reference to FIG. 1 to FIG. 3.

When the subject vehicle Am that has been traveling by the autonomous traveling control by the congestion level 3 stops, the automated driving ECU 50b continues the operation of the congestion level 3 as in the case of the stop due to congestion even if the reason for the stop is due to the operation of the emergency avoidance control, as illustrated in FIG. 9. Therefore, even if the emergency avoidance control is operated by interruption of another vehicle during the traveling in a congested interval, the automated driving ECU 50b automatically restarts the subject vehicle Am without requiring an input of the restarting trigger by the driver, similarly to the stop in the normal congestion.

In addition, when the subject vehicle Am that has been traveling by the autonomous traveling control by the congestion level 3 stops due to congestion, the automated driving ECU 50b does not require an input of the restarting trigger for restarting the subject vehicle Am regardless of the elapsed time after the stop. Therefore, even if the stopped state of the subject vehicle Am continues for a long time (e.g., for more than 30 seconds), the automated driving ECU 50b automatically restarts the subject vehicle Am so as to follow the restarted preceding vehicle.

When the subject vehicle Am that has been traveling by the autonomous traveling control by the congestion level 3 stops, the presentation control section 88 notifies, in response to the restarting control described above, that the automatic restarting will be executed by continued operation of the congestion level 3 as the traveling resumption information. In this case, an icon or a text message notifying the automatic restarting is displayed by the meter display 21 or the HUD 23. In addition, when the subject vehicle Am stops by the emergency avoidance control, a voice message or the like notifying the automatic restarting is reproduced by the audio device 24.

Furthermore, when the reason for the stop is due to the operation of the emergency avoidance control, the presentation control section 88 omits the notification of the traveling resumption information, indicating the execution of the automatic restarting, on the basis of the action information grasped by the information acquisition section 81. In detail, when the driver is not executing the periphery monitoring, the presentation control section 88 notifies the traveling resumption information. The traveling resumption information may include notification that urges the periphery monitoring. On the other hand, when the driver is executing the periphery monitoring, the presentation control section 88 omits the notification of the traveling resumption information so that the notification does not hinder the periphery monitoring that is being executed. However, when the elapsed time after the stop has exceeded a predetermined time (e.g., 30 seconds), the presentation control section 88 may notify the traveling resumption information even if the driver is executing the periphery monitoring.

In addition, the presentation control section 88 can start the notification of the traveling resumption information before the subject vehicle Am stops. In detail, the information cooperation section 82 can grasp not only the stop of the subject vehicle Am but also prediction of the stop of the subject vehicle Am on the basis of the control status information. When the information cooperation section 82 grasps the prediction of the stop of the subject vehicle Am, the presentation control section 88 starts the notification of the traveling resumption information even if the subject vehicle Am does not stop. Before the subject vehicle Am stops, the presentation control section 88 can notify the driver that an input of the restarting trigger by the driver is not required and restarting is automatically performed.

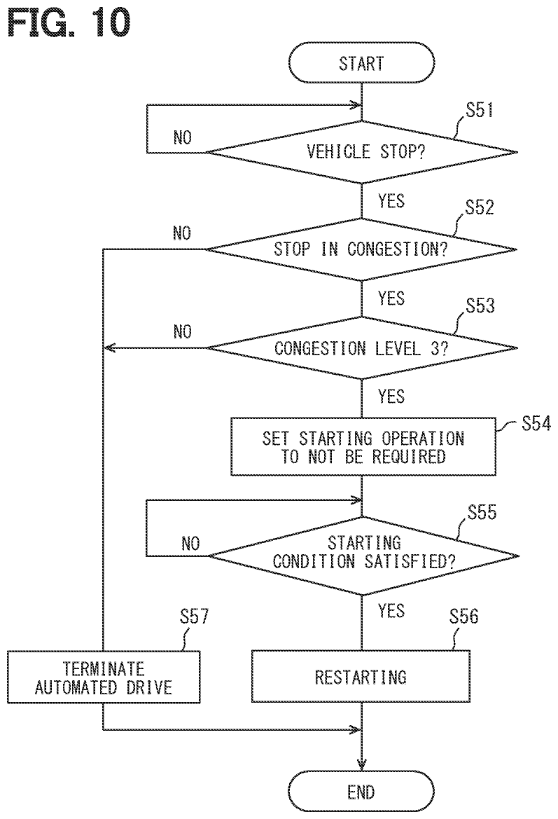

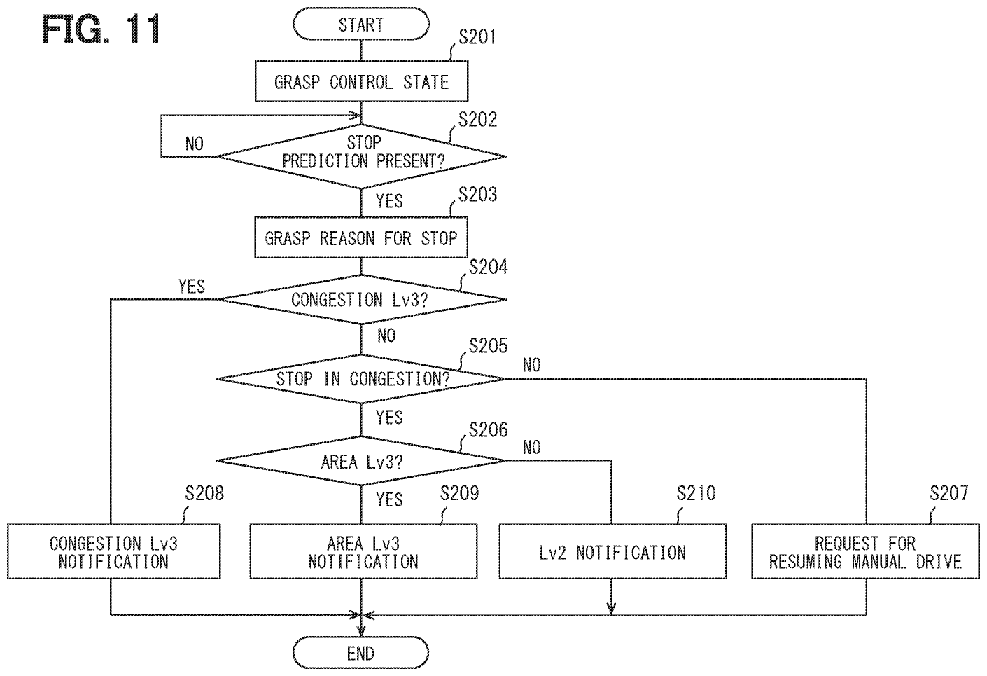

Next, details of each of starting control process and notification control process in the second embodiment will be described below based on FIG. 10 and FIG. 11 and with reference to FIG. 1 to FIG. 3 and FIG. 9.

The respective processing of S51 to S53 and S57 in the starting control process illustrated in FIG. 10 are substantially the same as those of S11 to S13 and S22 (see FIG. 5) in the first embodiment. When determining that the congestion level 3 is being executed (S53: YES), the automated driving ECU 50b builds a setting in which an input of the restarting trigger is not required (S54). Based on the satisfaction of the starting condition for the subject vehicle Am (S55: YES), the automated driving ECU 50b automatically restarts the subject vehicle Am while the autonomous traveling control by the congestion level 3 is continued (S56).

In S201 of the notification control process illustrated in FIG. 11, the control state of the traveling control executed by the automated driving system 50 is grasped. In S202, the prediction of the stop of the subject vehicle Am is grasped in addition to the stop of the subject vehicle Am. When the stop of or the prediction of the stop of the subject vehicle Am is grasped in S202, the reason for the current stop is further grasped in S203.

In S204, the information cooperation section 82 determines whether the congestion level 3 is being executed. When it is determined in S204 that the congestion level 3 is being executed, the presentation control section 88 notifies, in S208, the traveling resumption information corresponding to the congestion level 3. In this case, the driver is notified that the automatic restarting is scheduled to be executed by continuation of the congestion level 3. However, when the subject vehicle stops by the emergency avoidance control and the driver is executing the periphery monitoring, the notification, indicating that the automatic restarting is scheduled to be executed, is canceled.

In S205, the reason for the current stop is determined. When it is determined in S205 that the subject vehicle stops by the emergency avoidance control, the presentation control section 88 requests the driver to resume the traveling by manual driving in S207. On the other hand, when it is determined in S205 that the subject vehicle stops due to the normal stop in congestion, the information cooperation section 82 determines in S206 whether the area level 3 is being executed.

When it is determined in S206 that the area level 3 is being executed, the presentation control section 88 notifies the traveling resumption information corresponding to the area level 3 in S209. In this case, the driver is requested to resume the traveling by manual driving. On the other hand, when it is determined in S206 that the driving assistance control is being executed rather than the area level 3, the presentation control section 88 notifies the traveling resumption information corresponding to the driving assistance control in S210. In this case, it is notified as the traveling resumption information that the automatic restarting by the ACC function will be executed or that the restarting trigger is required for resuming the traveling by the ACC function.

The second embodiment described so far also has the same effects as those of the first embodiment, and the driver can know an action after the stop by the control by the automated driving system 50 from the traveling resumption information. Therefore, the convenience of the automated driving without obligation to monitor the periphery can be ensured.

In addition, when the subject vehicle Am stops during the execution of the congestion level 3 in the second embodiment, the driver is notified that automatic traveling by the congestion level 3 is scheduled to be resumed, regardless of whether the reason for the stop is due to the operation of the emergency avoidance control. According to such simplification of the restarting control, the driver can relievedly use the automated driving by the autonomous traveling control.

In the second embodiment, when the subject vehicle Am is predicted to stop, the traveling resumption information is notified earlier than the stop of the subject vehicle Am. Therefore, the driver can grasp at an early timing an action to take after the stop of the subject vehicle Am. As a result, in a scene where the autonomous traveling control is released, it becomes easy to secure the time for checking the situation around the subject vehicle, and thus the convenience of the automated driving is less likely to be impaired.

Furthermore, when the subject vehicle Am that has been traveling by the autonomous traveling control by the congestion level 3 stops due to congestion in the second embodiment, an input by the driver is not required for restarting the subject vehicle Am even if the elapsed time after the stop exceeds the predetermined time. According to the above, after the stop of the subject vehicle Am, a driver action like grasping the situation around the subject vehicle is not required, and thus a situation, in which the driver does not know what to do, does not substantially occur. Therefore, the convenience of the automated driving without obligation to monitor the periphery can be ensured.

Note that, in the second embodiment, the driving assistance ECU 50a corresponds to the “first traveling control section”, the action determination section 63 corresponds to the “traveling control section” and the “second traveling control section”, and the information acquisition section 81 corresponds to the “monitoring grasping section”.

### Third Embodiment

A third embodiment of the present disclosure is another modification of the first embodiment. The third embodiment is different from the first embodiment in restarting control in a case where the congestion level 3 and the area level 3 are being executed.

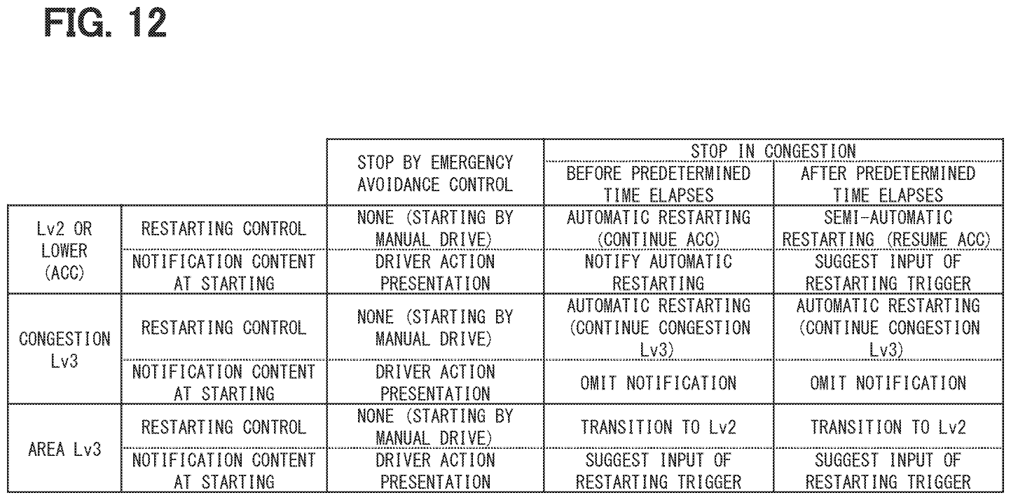

As illustrated in FIG. 12, when the subject vehicle Am that has been traveling by the autonomous traveling control by the congestion level 3 stops due to congestion, the automated driving ECU 50b does not require an input of the restarting trigger for restarting the subject vehicle Am, regardless of the elapsed time after the stop, similarly to the second embodiment. Therefore, even if the elapsed time after the stop has exceeded the predetermined time, the automated driving ECU 50b continues the operation of the congestion level 3 and automatically restarts the subject vehicle Am.

When the subject vehicle Am that has been traveling by the autonomous traveling control by the area level 3 stops due to congestion, the automated driving ECU 50b causes it to make a transition to the driving assistance control by the driving assistance ECU 50a (or the automated driving ECU 50b). The driving assistance ECU 50a requires an input of the restarting trigger for restarting the subject vehicle Am regardless of the elapsed time after the stop. Based on the input of the restarting trigger by the driver who has checked the situation around the subject vehicle, the driving assistance ECU 50a starts traveling by the ACC function.

When the subject vehicle Am that has been traveling by the autonomous traveling control by the congestion level 3 stops, the presentation control section 88 omits, in response to the restarting control described above, the notification of the traveling resumption information. Therefore, even if the predetermined time has elapsed since the stop due to congestion, the notification of the traveling resumption information is not executed. On the other hand, when the subject vehicle Am that has been traveling by the autonomous traveling control by the area level 3 stops, the presentation control section 88 executes notification that suggests or urges an input of the restarting trigger.

Also, in the third embodiment described above, the driver can know an action after the stop by the control by the automated driving system 50 from the traveling resumption information, similarly to the first embodiment. In addition, when the subject vehicle Am that has been traveling by the autonomous traveling control by the congestion level 3 stops due to congestion in the third embodiment, an input by the driver is not required for restarting the subject vehicle Am regardless of the elapsed time after the stop, similarly to the second embodiment. Thus, even in the third embodiment, the convenience of the automated driving without obligation to monitor the periphery can be ensured.

In addition, when the subject vehicle Am that has been traveling by the driving assistance control stops due to congestion in the third embodiment, an input of the restarting trigger is requested as the input by the driver for restarting the subject vehicle Am on the basis of the lapse of the predetermined time from the stop. On the other hand, when the subject vehicle Am that has been traveling by the autonomous traveling control by the congestion level 3 stops due to congestion, the notification of the traveling resumption information is omitted, and the request for inputting the restarting trigger is also canceled. According to the above, when the subject vehicle stops during the execution of the congestion level 3 due to congestion, the driver may continue the second task. Therefore, the convenience of the automated driving without obligation to monitor the periphery is further improved.

### Fourth Embodiment

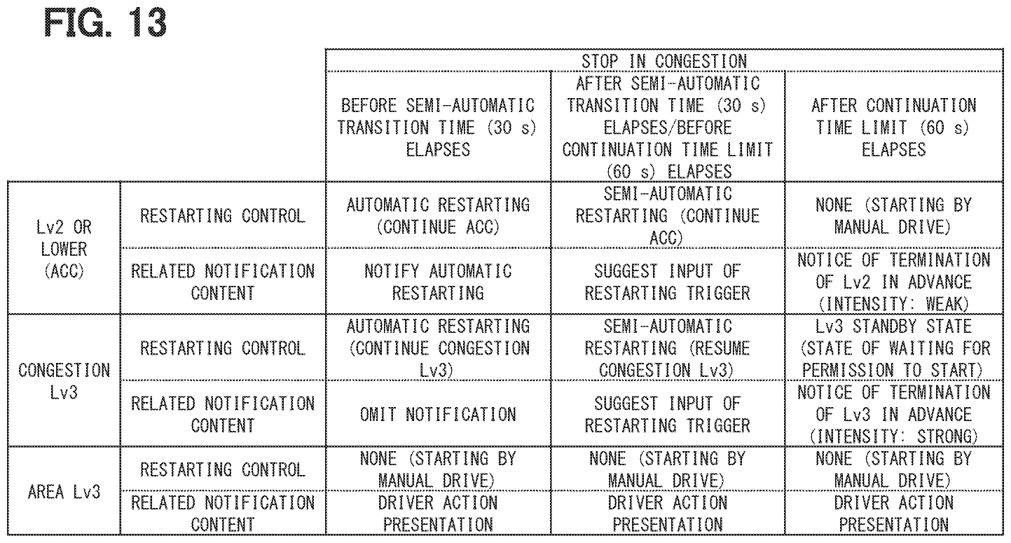

A fourth embodiment of the present disclosure is yet another modification of the first embodiment. In the fourth embodiment, a continuation time limit is set separately from the above predetermined time (hereinafter, semi-automatic transition time) as a threshold time to be compared with the elapsed time after the stop in congestion. Hereinafter, details of restarting control and information presentation related to the control in the fourth embodiment will be described based on FIG. 13 to FIG. 17 and with reference to FIG. 1 to FIG. 3, FIG. 5, and FIG. 8. Note that, in the table illustrated in FIG. 13, description related to the control in a scene where the subject vehicle stops by the emergency avoidance control is omitted. The control in the fourth embodiment in the scene where the subject vehicle stops by the emergency avoidance control is substantially the same as the control in the first embodiment (see FIG. 4).

<Scene where Vehicle Under Driving Assistance Control Stops Due to Congestion>

When the subject vehicle Am that has been traveling by the driving assistance control (ACC function) at the automated driving level 2 or lower stops in congestion, the driving assistance ECU 50a determines whether the elapsed time after the stop has exceeded the continuation time limit. The continuation time limit is set to a time (e.g., about 60 seconds) longer than the semi-automatic transition time.

When the elapsed time after the stop has passed the semi-automatic transition time and is before the continuation time limit elapses, the driving assistance ECU 50a restarts, based on an input of the restarting trigger by the driver, the subject vehicle Am and resumes the follow-up traveling, similarly to the first embodiment. On the other hand, when the elapsed time after the stop exceeds the continuation time limit, the driving assistance ECU 50a releases the driving assistance control. The released state of the driving assistance control is a state in which the restarting by the input of at least the restarting trigger is not executed. In the fourth embodiment, the traveling control state of the subject vehicle Am makes a transition to the state of manual driving by the release of the driving assistance control. As a result, a normal accelerator operation different from the restarting trigger is required for restarting the subject vehicle Am.

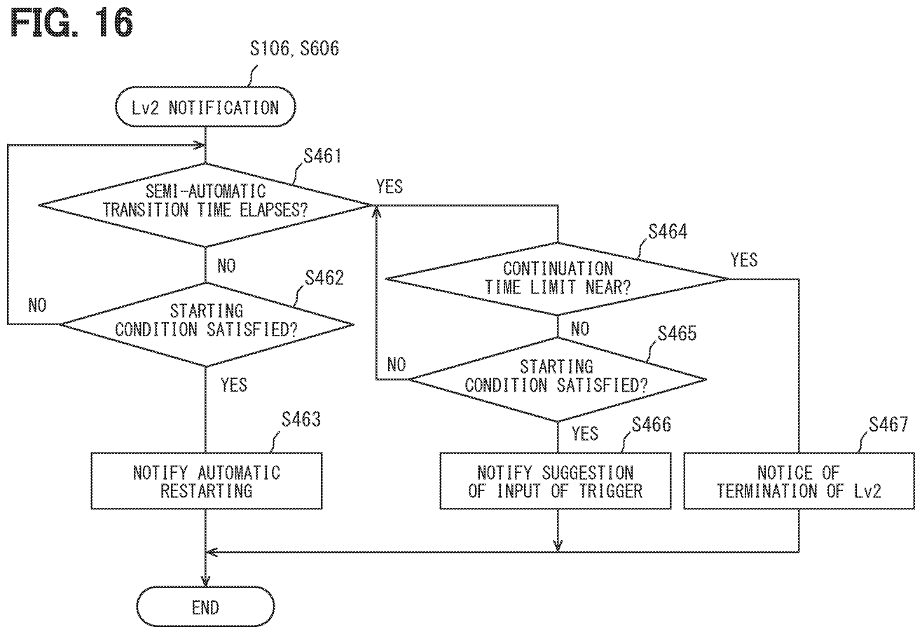

Before the elapsed time after the stop exceeds the continuation time limit, the presentation control section 88 gives, in response to the release process of the driving assistance control described above, a notice of the termination (release) of the driving assistance control (see S467 in FIG. 16). A notice of the termination of the driving assistance control is started, for example, several seconds to 10 seconds before the continuation time limit. The notice of the termination of the driving assistance control is notification that give a notice that the driving assistance control is terminated due to continued stop in congestion. In the notice of the termination of the driving assistance control, a message, such as “Transition to manual driving will be made soon”, is displayed by the meter display 21 and the HUD 23. Furthermore, when the elapsed time after the stop has exceeded the continuation time limit, the presentation control section 88 uses the meter display 21 and the HUD 23 to notify that the control state of the subject vehicle Am has made a transition to manual driving.

<Scene where Subject Vehicle Under Autonomous Traveling Control Stops Due to Congestion>

When the subject vehicle Am that has been traveling by the autonomous traveling control by the congestion level 3 stops in congestion, the environment recognition section 62 determines whether the elapsed time after the stop has exceeded the continuation time limit. The continuation time limit set for the autonomous traveling control may be the same as the continuation time limit set for the driving assistance control, and is set to, for example, about 60 seconds.

When the elapsed time after the stop is before the continuation time limit elapses, the automated driving ECU 50b restarts, based on an input of the restarting trigger by the driver, the subject vehicle Am and resumes the follow-up traveling by the congestion level 3, similarly to the first embodiment. On the other hand, when the elapsed time after the stop exceeds the continuation time limit, the automated driving ECU 50b causes the autonomous traveling control to make a transition to a standby state. The standby state of the autonomous traveling control is a state in which at least the periphery monitoring by the driver is required for resuming the traveling, and is a suspended state in which permission to start, based on a command from the driver, is being waited for. In the standby state of the autonomous traveling control, for example, the traveling environment recognition around the subject vehicle is being continued. In the fourth embodiment, when the autonomous traveling control makes a transition to the standby state, the subject vehicle Am is caused to remain stopped by the driving assistance control (ACC function) of the automated driving ECU 50b or the driving assistance ECU 50a. By inputting the restarting trigger upon executing the periphery monitoring, the driver can restart the subject vehicle Am and resume the follow-up traveling by the congestion level 3.

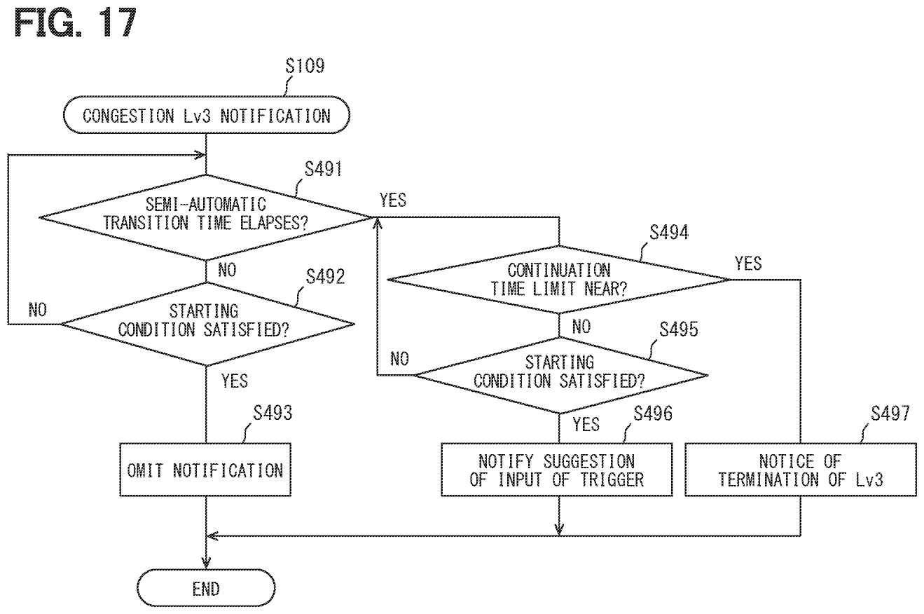

Before the elapsed time after the stop exceeds the continuation time limit, the presentation control section 88 gives, in response to the standby transition process of the autonomous traveling control described above, a notice of the termination (standby transition) of the autonomous traveling control (see S497 in FIG. 17). The notice of the termination of the autonomous traveling control is started several seconds to 10 seconds before the continuation time limit, similarly to the notice of the termination of the driving assistance control. Since the notice of the termination of the autonomous traveling control is a notice requesting the driver to terminate the second task, the notification intensity is set to be higher than that of the notice of the termination of the driving assistance control. Specifically, in the notice of the termination of the autonomous traveling control, a message, such as “Automated driving will be terminated soon”, is displayed by the meter display 21 and the HUD 23 in a more emphasized manner than that in the notice of the termination of the driving assistance control. When a content related to the second task is displayed on the CID 22, a message, giving a notice of the termination of the autonomous traveling control, may be presented in a form of hindering the visual recognition of a content being displayed. Furthermore, a voice message, giving a notice of the termination of the autonomous traveling control, may be reproduced by the audio device 24. When the elapsed time after the stop has exceeded the continuation time limit, the presentation control section 88 uses the meter display 21 and the HUD 23 to notify the driver that it is required to check the periphery of the subject vehicle and that it is required to input the restarting trigger.

Also, in the fourth embodiment, when the subject vehicle Am that has been traveling by the autonomous traveling control by the area level 3 stops in congestion, the automated driving ECU 50b stops the operation of the area level 3 and switches the traveling control state of the subject vehicle Am to manual driving. That is, when the subject vehicle is traveling by the area level 3, the comparison of the elapsed time after the stop with the semi-automatic transition time and the continuation time limit may be omitted.

The driving assistance ECU 50a and the automated driving ECU 50b can change the continuation time limit depending on the type of a road on which the subject vehicle Am travels, similarly to the semi-automatic transition time. As an example, when the subject vehicle Am is traveling on an expressway and an automobile exclusive road, the continuation time limit is set to about 60 seconds described above. On the other hand, when the subject vehicle Am is traveling on a general road, the continuation time limit is set to a longer time than when traveling on an expressway and the like, specifically, to about several minutes to 10 minutes. Furthermore, the continuation time limit set for the autonomous traveling control may be different from the continuation time limit set for the driving assistance control. Specifically, the continuation time limit associated with the autonomous traveling control may be longer than the continuation time limit associated with the driving assistance control, or may be shorter than the continuation time limit associated with the driving assistance control.

Next, details of each of the starting control process and a level 3 return process for realizing the restarting control described so far and the notification control process for realizing the notification related to the control will be described below on the basis of FIG. 5 and FIG. 14 to FIG. 17 and with reference to FIG. 1 to FIG. 3 and FIG. 8.

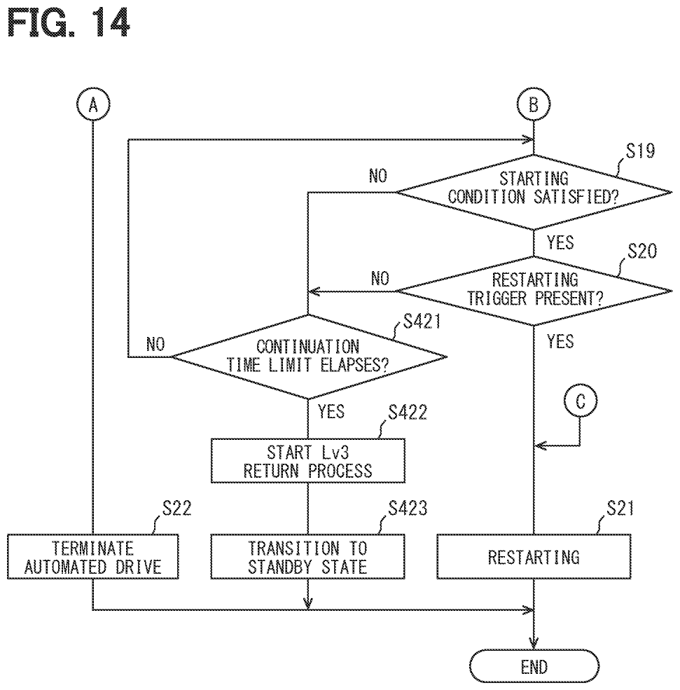

In the starting control process illustrated in FIG. 5 and FIG. 14, the respective processing of S11 to S18 (see FIG. 5) are substantially the same as those in the first embodiment. After the elapsed time after the stop due to congestion exceeds the semi-automatic transition time (S16: YES) and it is set to a state in which the restarting trigger for restarting is required, the environment recognition section 62 determines in S19 whether the starting condition for the subject vehicle Am is satisfied. When it is determined in S19 that the starting condition for the subject vehicle Am is not satisfied, the process proceeds to S421.

On the other hand, when it is determined in S19 that the starting condition is satisfied, the process proceeds to S20, where the information cooperation section 61 or the action determination section 63 determines the presence or absence of a driver operation to serve as the restarting trigger. When it is determined in S20 that the driver operation to serve as the restarting trigger has been input, the process proceeds to S21, where the subject vehicle Am is restarted while the autonomous traveling control by the congestion level 3 is continued. On the other hand, when it is determined that the driver operation to serve as the restarting trigger has not been input, the process proceeds from S20 to S421.

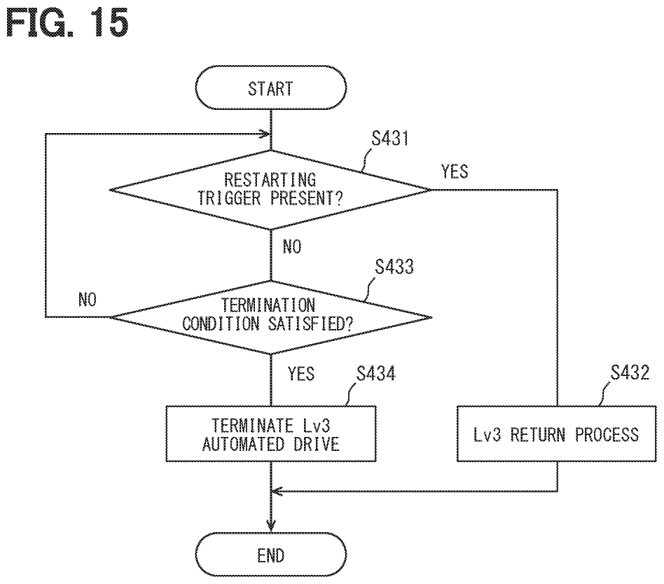

In S421, the environment recognition section 62 determines whether the elapsed time after the stop exceeds the continuation time limit. When it is determined in S421 that it is before the continuation time limit elapses, the process returns to S19. On the other hand, when it is determined in S421 that it is after the continuation time limit elapses, the level 3 return process (see FIG. 15) is started in S422. Then, the action determination section 63 causes, in S423, the traveling control state of the subject vehicle Am to make a transition to the standby state of the autonomous traveling control.

In S431 of the level 3 return process illustrated in FIG. 15, the information cooperation section 61 or the action determination section 63 determines the presence or absence of the driver operation to serve as the restarting trigger. The restarting trigger grasped in S431 may be a driver operation for executing the semi-automatic restarting, specifically, a bush operation on a resume button, a set button, or the like; an operation of temporarily stepping on the accelerator pedal; or the like. In addition, in S431, it may be further determined whether the periphery monitoring by the driver has been executed based on, for example, information from a driver monitoring device.

When it is determined in S431 that the driver operation to serve as the restarting trigger has been grasped, the action determination section 63 starts a return process to the congestion level 3 in S432. Thus, the action determination section 63 terminates the standby state of the autonomous traveling control and resumes the operation of the autonomous traveling control. As a result, the follow-up traveling by the congestion level 3 is resumed.

On the other hand, when it is determined in S431 that the driver operation to serve as the restarting trigger is not grasped, the process proceeds to S433. In S433, the action determination section 63 determines whether a termination condition can be satisfied. For example, when a time longer than the continuation time limit (e.g., 15 minutes or more) has elapsed since the stop due to congestion or when the preceding vehicle to be followed cannot be detected, the action determination section 63 determines that the termination condition is satisfied. When it is determined in S433 that the termination condition is not satisfied, the process returns to S431. On the other hand, when it is determined in S433 that the termination condition is satisfied, the process proceeds to S434. In S434, the action determination section 63 terminates the autonomous traveling control by the congestion level 3 that has been caused to remain in the standby state. As a result, the subject vehicle Am makes a transition to the state of manual driving.

Each notification execution process illustrated in FIG. 16 and FIG. 17 is executed in cooperation with the HCU 100 and the driving assistance ECU 50a as a sub-process of the notification control process (see FIG. 8). In detail, the notification execution process illustrated in FIG. 16 is started based on that, in the notification control process, execution of the information presentation (see S106) corresponding to the driving assistance control at level 2 has been determined. Similarly, the notification execution process illustrated in FIG. 17 is started based on that, in the notification control process, execution of the information presentation (see S109) corresponding to the congestion level 3 has been determined. Each notification execution process may be mainly executed by the driving assistance ECU 50a or the automated driving ECU 50b (information cooperation section 61), or may be mainly executed by the presentation control section 88 of the HCU 100.

In S461 of the notification execution process illustrated in FIG. 16, it is determined whether the elapsed time after the stop due to congestion has exceeded the semi-automatic transition time. When it is determined in S461 that it is before the semi-automatic transition time elapses, the process proceeds to S462. In S462, it is determined whether the starting condition is satisfied. When it is determined in S462 that the starting condition is not satisfied, the process returns to S461. On the other hand, when it is determined in S462 that the starting condition is satisfied, the process proceeds to S463. In S463, execution of the automatic restarting by the ACC function is notified as the traveling resumption information.

When it is determined in S461 that it is after the semi-automatic transition time elapses, the process proceeds to S464. In S464, it is determined whether the lapse of the continuation time limit is drawing near, in other words, whether it is a timing several seconds to 10 seconds before the continuation time limit. When it is determined in S464 that there is leeway until the continuation time limit elapses, the process proceeds to S465. In S465, it is determined whether the starting condition is satisfied, similarly to S462. When it is determined in S465 that the starting condition is not satisfied, the process returns to S464. On the other hand, when it is determined in S465 that the starting condition is satisfied, the process proceeds to S466. In S466, notification, suggesting that an input of the restarting trigger is required for resuming the traveling by the ACC function, is executed.

When it is determined in S464 that it is a timing several seconds to 10 seconds before the continuation time limit and the elapsed time after the stop is drawing close to the continuation time limit, the process proceeds to S467. In S467, a notice of the termination of the driving assistance control is given. As described above, the notification intensity of the notice of the termination of the driving assistance control is set to be weaker than the notification intensity of the notice of the termination (see S497 in FIG. 17) of the autonomous traveling control (see FIG. 13).

In S491 of the notification execution process illustrated in FIG. 17, it is determined whether the elapsed time after the stop due to congestion has exceeded the semi-automatic transition time. When it is determined in S491 that it is before the semi-automatic transition time elapses, it is determined in S492 whether the starting condition is satisfied. When it is determined in S492 that the starting condition is not satisfied, the process returns to S491. On the other hand, when it is determined that the starting condition is satisfied, the notification related to the automatic restarting is omitted (S493), and the notification execution process is terminated.

When it is determined in S491 that it is after the semi-automatic transition time elapses, the process proceeds to S494. In S494, it is determined whether the lapse of the continuation time limit is drawing near, and when it is determined that there is leeway until the continuation time limit elapses, the process proceeds to S495. In S495, it is determined whether the starting condition can be satisfied, and when it is determined that the starting condition is not satisfied, the process returns to S494. On the other hand, when it is determined in S495 that the starting condition is satisfied, notification, suggesting that an input of the restarting trigger is required, is executed in S496.

When it is determined in S494 that the elapsed time after the stop due to congestion is drawing near to the continuation time limit, the process proceeds to S497. In S497, a notice of the termination of the autonomous traveling control by the congestion level 3 is given. Such a notice of termination is notification that also serves as a notice of the termination of the second task. As described above, the notification intensity of the notice of the termination of the autonomous traveling control is set to be stronger than the notification intensity of the notice of the termination of the driving assistance control (see FIG. 13).

Even in the fourth embodiment described so far, the same effects as those of the first embodiment can be obtained, and the convenience of the automated driving can be ensured. In detail, when the elapsed time after the stop due to congestion exceeds the continuation time limit in the fourth embodiment, the autonomous traveling control makes a transition to the standby state. Therefore, it is possible to resume the traveling of the subject vehicle Am by the autonomous traveling control without requiring a complicated operation by the driver. As a result, a situation, in which the driver does not know what to do after the stop, can be avoided. Therefore, the convenience of the automated driving without obligation to monitor the periphery can be ensured.

In addition, when an input of the specific restarting trigger by the driver is grasped after the transition to the standby state in the fourth embodiment, the action determination section 63 terminates the standby state and resumes the operation of the autonomous traveling control. According to such setting of the restarting trigger, the driver can easily resume the traveling of the subject vehicle Am by the autonomous traveling control. Therefore, the convenience of the automated driving can be further ensured.

In the fourth embodiment, notification that gives a notice of the termination of the autonomous traveling control is executed before the elapsed time after the stop due to congestion exceeds the continuation time limit. Therefore, even if the driver is executing the second task and is not focusing on driving, the driver can cope with the transition of the autonomous traveling control to the standby state with leeway.

Furthermore, in the fourth embodiment, the notification that gives a notice of the termination of the autonomous traveling control is emphasized more than the notification that gives a notice of the termination of the driving assistance control in which the driver is obliged to monitor the periphery. Therefore, even if the driver is more likely to tend to be distracted from driving during the execution of the autonomous traveling control than during the execution of the driving assistance control, it is possible to make the driver focus on driving until the continuation time limit elapses. According to the above, the driver can quickly cope with the transition of the autonomous traveling control to the standby state. Therefore, the convenience of the automated driving can be further ensured.

Note that, in the fourth embodiment, the information cooperation section 61 corresponds to the “notification control section”, and the specific driver operation in S431 to be grasped as the restarting trigger corresponds to the “resuming operation”.

### Fifth Embodiment

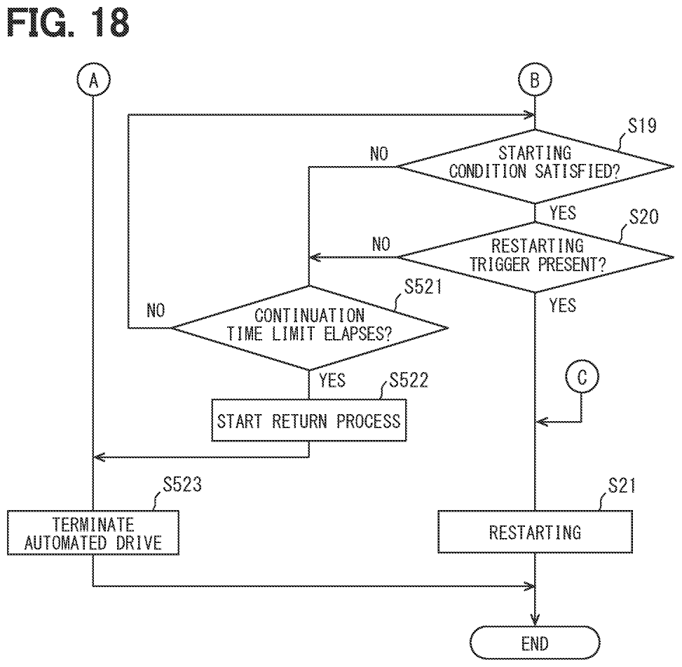

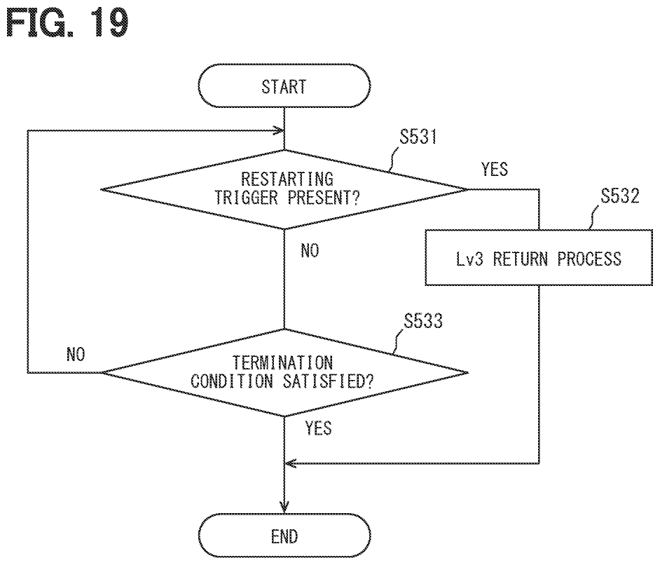

A fifth embodiment of the present disclosure is a modification of the fourth embodiment. In the fifth embodiment, when the elapsed time after the stop due to congestion exceeds the continuation time limit, the autonomous traveling control is released. Hereinafter, details of a starting control process and a level 3 return process in the fifth embodiment will be described based on FIG. 5, FIG. 18, and FIG. 19 and with reference to FIG. 1 to FIG. 3.

In the starting control process illustrated in FIG. 5 and FIG. 18, the respective processing of S11 to S18 (see FIG. 5), S19, and S20 are substantially the same as those in the first embodiment and the fourth embodiment. When it is determined in S19 that the starting condition for the subject vehicle Am is not satisfied or when it is determined in S20 that a driver operation to serve as the restarting trigger is not input, the environment recognition section 62 compares, in S521, the elapsed time after the stop due to congestion with the continuation time limit.

When it is determined in S521 that it is after the continuation time limit elapses, the action determination section 63 releases the autonomous traveling control. The released state of the autonomous traveling control is a state in which the level 3 return process (see FIG. 19) is executed and then the autonomous traveling control is terminated. In the state in which the autonomous traveling control is released (terminated), for example, the process for recognizing the environment around the subject vehicle is stopped. When it is determined in S521 that the elapsed time after the stop has exceeded the continuation time limit, the level 3 return process is started in S522. Furthermore, the automatic traveling control by the congestion level 3 is terminated in S523. As a result, the traveling control state of the subject vehicle Am makes a transition to the state of manual driving. Note that the level 3 return process may be executed after the process for terminating the automatic traveling control.

In S531 in the level 3 return process illustrated in FIG. 19, the presence or absence of a driver operation to serve as the restarting trigger is determined. When an input of the restarting trigger is not grasped in S531, it is determined in S533 whether the termination condition can be satisfied. When it is determined in S533 that the termination condition is satisfied, the automated driving ECU 50b terminates the level 3 return process.

On the other hand, when an input of the restarting trigger is grasped in S531, the action determination section 63 starts, in S532, the process for returning to the congestion level 3. The action determination section 63 returns the traveling control state of the subject vehicle Am from the state of manual driving to the state of the autonomous traveling control without going through the state of the driving assistance control. As a result, the follow-up traveling by the congestion level 3 is resumed.

Also, in the fifth embodiment described so far, the same effects as those of the fourth embodiment are obtained. In detail, when the elapsed time after the stop due to congestion exceeds the continuation time limit in the fifth embodiment, the autonomous traveling control is brought into a released state in which return to the autonomous traveling control is possible by an input of the specific restarting trigger by the driver. Therefore, it is possible to resume the traveling of the subject vehicle Am by the autonomous traveling control without requiring a complicated operation by the driver. As a result, a situation, in which the driver does not know what to do after the stop, can be avoided.

In the fifth embodiment, although the process by the automated driving ECU 50b, in a case where the continuation time limit is exceeded, is different from that in the fourth embodiment, the driver can resume the traveling by the congestion level 3 by executing the periphery monitoring and inputting the restarting trigger, as described above. Therefore, the convenience of the automated driving without obligation to monitor the periphery can be ensured.

### Sixth Embodiment

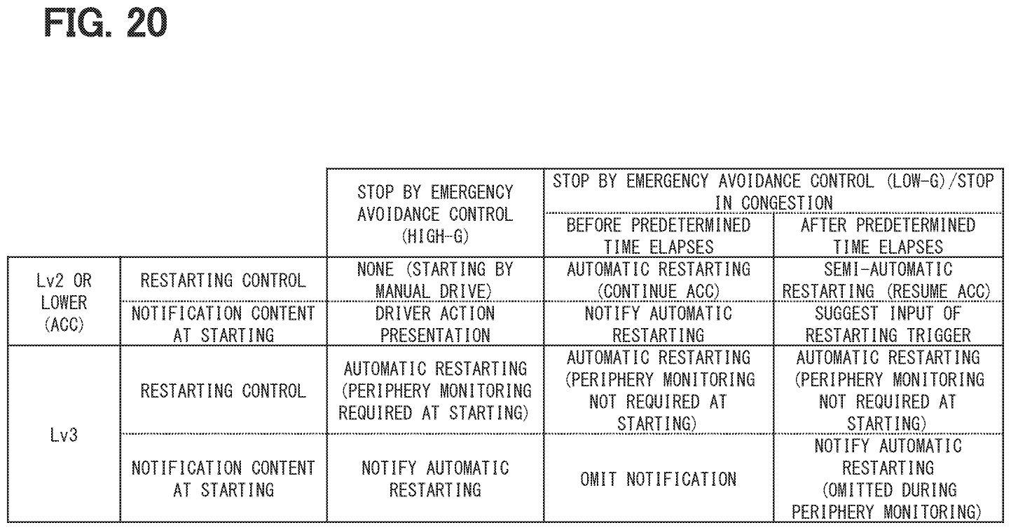

A sixth embodiment of the present disclosure is another modification of the second embodiment. In the sixth embodiment, the function of the automated driving ECU 50b that switches the control mode of the autonomous traveling control is omitted. The automated driving ECU 50b enables, without switching the control mode, the autonomous traveling by the autonomous traveling control on an expressway and a general road on which the use of the automated driving function at level 3 is permitted. In addition, when the subject vehicle Am that has been traveling by the autonomous traveling control stops in the sixth embodiment, action information, indicating whether the periphery monitoring by the driver is being executed, is used for the restarting control of the subject vehicle Am and notification of the traveling resumption information. Hereinafter, details of the restarting control and information presentation related to the control in the sixth embodiment will be described based on FIG. 20 to FIG. 24 and with reference to FIG. 1 to FIG. 3.

When the subject vehicle Am stops by emergency avoidance (hereinafter, emergency stop) that is caused due to a risk target occurring around the subject vehicle, such as sudden interruption of another vehicle, the automated driving ECU 50b grasps the magnitude of acceleration in the deceleration direction (hereinafter, deceleration G) occurring in the subject vehicle Am. Acceleration information indicating the deceleration G is measured by an acceleration sensor, an inertial measurement unit (IMU), or the like mounted on the subject vehicle Am, and is provided to the automated driving ECU 50b, the HCU 100, and the like. The automated driving ECU 50b acquires the acceleration information by the environment recognition section 62, and grasps the magnitude of the deceleration G when the subject vehicle Am stops.

The automated driving ECU 50b changes the content of the restarting control by the action determination section 63 depending on whether the deceleration G is equal to or greater than a predetermined value. The predetermined value is determined based on the deceleration G generated when the emergency avoidance control section 78 activates the AEB. As an example, the predetermined value is set to 1 G. The predetermined value is compared with the maximum value of the deceleration G occurring at the time of the emergency stop. When the absolute value of the maximum value of the deceleration G, which is acceleration in the negative direction, is equal to or greater than 1 G, the action determination section 63 determines that the subject vehicle has stopped due to high-G emergency avoidance control. In this case, based on the action information grasped by the information cooperation section 61, the action determination section 63 permits the resumption of the traveling of the subject vehicle Am by the autonomous traveling control on condition that the driver is executing the periphery monitoring.

On the other hand, when the maximum value of the deceleration G does not exceed 1 G, the action determination section 63 determines that the subject vehicle has stopped due to low-G emergency avoidance control. In this case, the action determination section 63 executes restarting control similar to that in a case where the subject vehicle stops following the preceding vehicle in congestion or the like, and permits resumption of the traveling of the subject vehicle Am by autonomous traveling control regardless of whether the driver is executing the periphery monitoring.

Here, when the emergency avoidance control section 78 activates the AEB, it may be determined that the subject vehicle has stopped by the high-G emergency avoidance control in which the deceleration G is equal to or greater than the predetermined value. In such a mode, when the AEB is not activated by the emergency avoidance control section 78 and the subject vehicle Am has been stopped by the normal deceleration control, the action determination section 63 determines that the subject vehicle has stopped by the low-G emergency avoidance control. Note that, in a case where the deceleration G is equal to the predetermined value, the high-G emergency avoidance control may be the reason for the stop as described above, or it may be assigned to the low-G emergency avoidance control.

The HCU 100 corresponds to the restarting control of the automated driving ECU 50b described above, and changes the control content of the information presentation for notifying the traveling resumption information depending on whether the deceleration G exceeds the predetermined value and whether the driver is executing the periphery monitoring. In detail, based on the control status information provided from the automated driving ECU 50b, the information cooperation section 82 grasps the magnitude of the deceleration G in a case where the subject vehicle Am stops, and determines whether the current stop of the subject vehicle Am is stop by the high-G emergency avoidance control.

When the deceleration G exceeds the predetermined value described above (hereinafter, notification threshold) and the current emergency stop is stop by the high-G emergency avoidance control, the presentation control section 88 notifies, as the traveling resumption information, the execution of the automatic restarting by the autonomous traveling control. When the autonomous traveling control is continued even after the automatic restarting, hands-on notification is not included in the notification as the traveling resumption information. The hands-on notification is executed, for example, when the automated driving level makes a transition to or lower than hands-on driving assistance control, in which the driver is requested to grip the steering wheel (corresponding to a steering portion). In the hands-on notification, a content including an icon resembling the steering wheel is displayed on the display device.

On the other hand, when the current stop of the subject vehicle Am is stop by the low-G emergency avoidance control or stop in congestion, the presentation control section 88 omits the notification of the traveling resumption information before the elapsed time after the stop does not exceed a predetermined time (hereinafter, notification start time). The notification start time is set to about 30 seconds similarly to the predetermined time in the first embodiment and the semi-automatic transition time in the fourth embodiment. Then, when the elapsed time after the stop exceeds the notification start time, the presentation control section 88 notifies, as the traveling resumption information, the execution of the automatic restarting by the autonomous traveling control. However, when the driver is executing the periphery monitoring, the notification of the traveling resumption information may be omitted even if the elapsed time after the stop exceeds the notification start time.

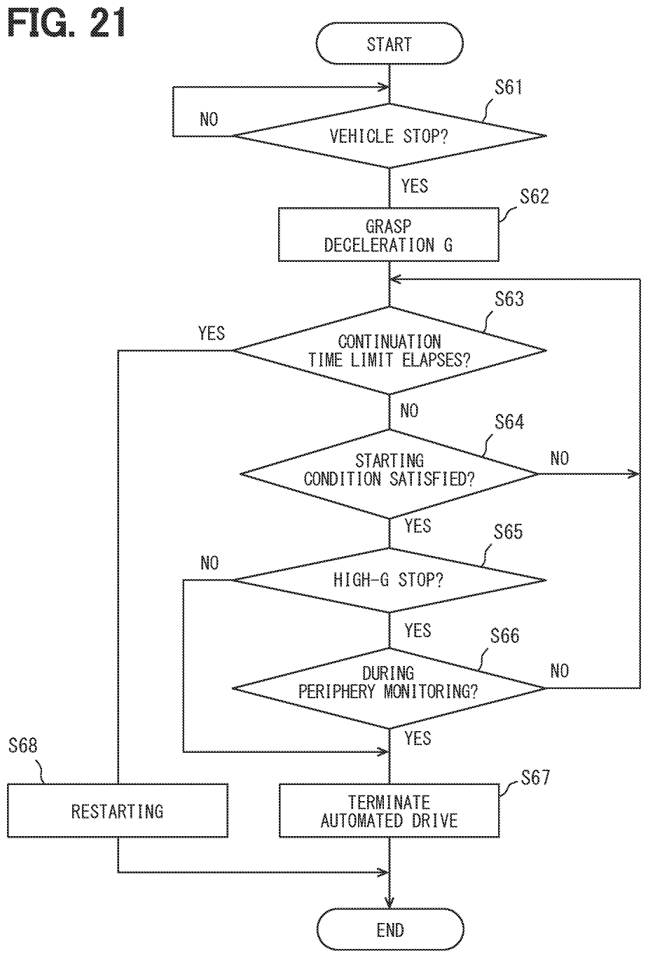

Next, details of each of the starting control process for realizing the restarting control described so far, and the notification control process and notification execution process for executing the notification related to the starting control process will be described below based on FIG. 21 to FIG. 24 and with reference to FIG. 1 to FIG. 3 and FIG. 20.

When determining, in S61 in the starting control process illustrated in FIG. 21, the stop of the subject vehicle Am that has been traveling by the autonomous traveling control, the environment recognition section 62 grasps, in S62, the magnitude of the deceleration G occurring at the time of the stop. In S63, the environment recognition section 62 determines whether the elapsed time after the stop has exceeded the continuation time limit. The continuation time limit may be set to about 60 seconds or may be set to about several minutes to 10 minutes. When the elapsed time after the stop has exceeded the continuation time limit, the process proceeds to S68, where the autonomous traveling control (automated driving) that is being executed is terminated.

On the other hand, when determining in S63 that the elapsed time after the stop does not exceed the continuation time limit, the environment recognition section 62 determines in S64 whether the starting condition for the subject vehicle Am is satisfied. When it is determined in S64 that the starting condition is not satisfied, the process returns to S63, where the satisfaction of the starting condition is waited for. On the other hand, when it is determined in S64 that the starting condition is satisfied, the environment recognition section 62 determines in S65 whether the current stop of the subject vehicle Am is stop by the high-G emergency avoidance control.

When it is determined in S65 that the current stop of the subject vehicle Am is stop by the high-G emergency avoidance control, the information cooperation section 61 grasps in S66 whether the periphery monitoring by the driver is being executed on the basis of the action information. When it is determined in S66 that the periphery monitoring is not being executed, the process returns to S63, where the start of the periphery monitoring by the driver is waited for. On the other hand, when it is determined in S65 that the current stop of the subject vehicle Am is not the stop by the high-G emergency avoidance control, the determination in S66 is skipped. Then, the action determination section 63 automatically restarts the subject vehicle Am in S67 while continuing the autonomous traveling control at level 3.

In S601 in the notification control process illustrated in FIG. 21, when the control state of the traveling control executed by the automated driving system 50 is grasped by the information cooperation section 82, the stop of the subject vehicle Am is waited for in S602 by the information acquisition section 81 or the information cooperation section 82. When the stop of the subject vehicle Am is determined in S602, the information cooperation section 82 grasps, in S603, the magnitude of the deceleration G occurring in the subject vehicle Am. Furthermore, the information cooperation section 82 determines in S604 whether the autonomous traveling control at level 3 is being executed.

When the driving assistance control at level 2 or lower is being executed, the information cooperation section 82 determines in S605 whether the current stop of the subject vehicle Am is stop by the high-G emergency avoidance control. When it is stop by the low-G emergency avoidance control or due to normal stop following the preceding vehicle in congestion or the like, the presentation control section 88 executes, in S606, notification of the traveling resumption information (see FIG. 16) corresponding to the driving assistance control at level 2. On the other hand, when it is stop by the high-G emergency avoidance control, the presentation control section 88 notifies, in S607, action presentation that requests the driver to resume the travel by manual driving, as the traveling resumption information.

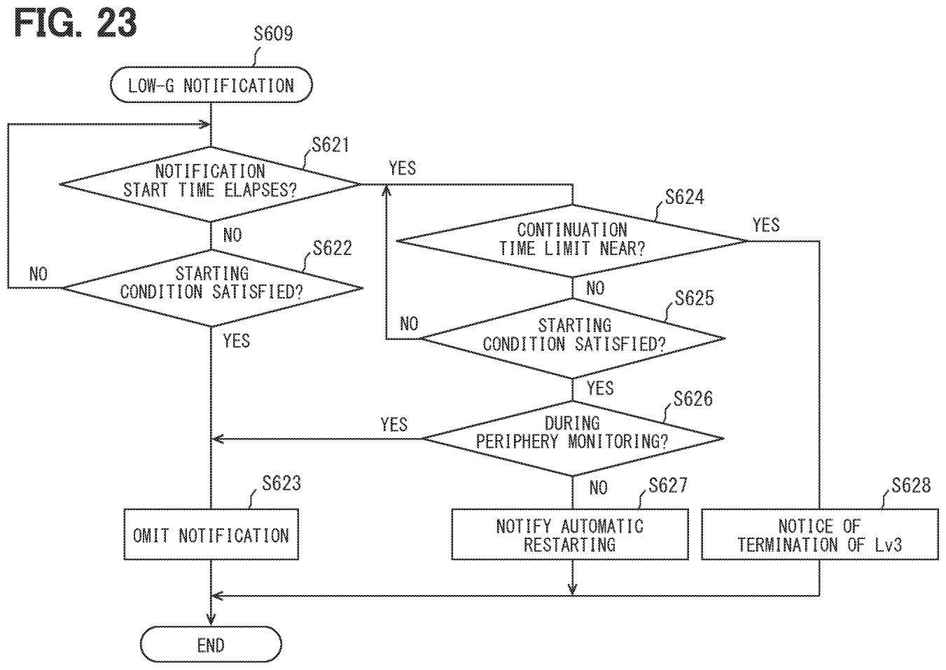

Even if the autonomous traveling control at level 3 is being executed, the information cooperation section 82 determines in S608 whether the current stop of the subject vehicle Am is stop by the high-G emergency avoidance control. When it is stop by the low-G emergency avoidance control or due to normal stop following the preceding vehicle in congestion or the like, the presentation control section 88 starts, in S609, a notification execution process (see FIG. 23) prepared for the stop by the low-G emergency avoidance control or the stop in congestion. As a result, notification of the traveling resumption information corresponding to the normal stop control is executed.

In S621 in the notification execution process executed in S609, it is determined whether the elapsed time after the stop has exceeded the notification start time. When it is determined in S621 that it is before the notification start time elapses, it is determined in S622 whether the starting condition is satisfied. When it is determined in S622 that the starting condition is not satisfied, the process returns to S621. On the other hand, when it is determined that the starting condition is satisfied, the notification related to the automatic restarting is omitted (S623), and the notification execution process is terminated. With such a process, the execution of the notification of the automatic restarting is suspended until the notification start time elapses.

On the other hand, when it is determined in S621 that it is after the notification start time elapses, it is determined in S624 whether the lapse of the continuation time limit is drawing near. When it is determined in S624 that the elapsed time is drawing near to the continuation time limit, a notice, indicating the termination of the level 3 automated driving, is given in S628. On the other hand, when it is determined in S624 that there is leeway until the continuation time limit elapses, it is determined in S625 whether the starting condition can be satisfied, similarly to S622. When it is determined that the starting condition is satisfied, it is determined in S626 whether the periphery monitoring by the driver is being executed. When the driver is executing the periphery monitoring, the notification related to the automatic restarting is omitted (S623). On the other hand, when the driver is not executing the periphery monitoring, the execution of the automatic restarting by the autonomous traveling control is notified as the traveling resumption information in S627.

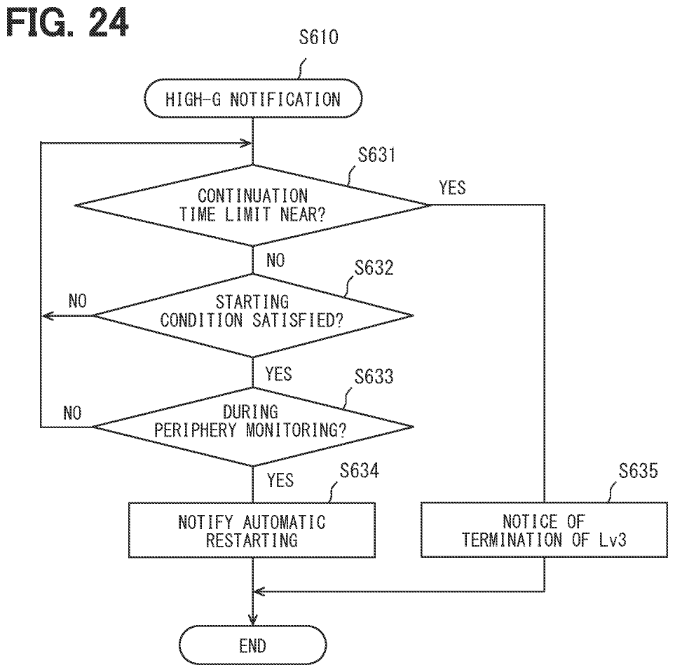

On the other hand, when the current stop of the subject vehicle Am is stop by the high-G emergency avoidance control, the presentation control section 88 starts, in S610, the notification execution process (see FIG. 24) prepared for the stop by the high-G emergency avoidance control. As a result, the notification of the traveling resumption information corresponding to high-G emergency stop is executed.

In S631 in the notification execution process executed in S610, it is determined whether the lapse of the continuation time limit is drawing near. When it is determined in S631 that the elapsed time is drawing near to the continuation time limit, a notice, indicating the termination of the level 3 automated driving, is given in S635. On the other hand, when it is determined in S631 that there is leeway until the continuation time limit elapses, it is determined in S632 whether the starting condition can be satisfied. When it is determined that the starting condition is satisfied, it is determined in S633 whether the periphery monitoring by the driver is being executed.

Here, in the case of the stop by the high-G emergency avoidance control, the automatic restarting of the subject vehicle Am is not permitted even if the driver is not executing the periphery monitoring in addition to the case where the starting condition is not satisfied. Therefore, when the driver is not executing the periphery monitoring, the start of the periphery monitoring by the driver is waited for by repeating the processing of S631 to S633. Then, when it is determined in S633 that the driver is executing the periphery monitoring, execution of the automatic restarting by the autonomous traveling control is notified as the traveling resumption information in S634. In the notification of the automatic restarting in this case, the hands-on notification as described above is not executed.

Even in the sixth embodiment described so far, the same effects as those of the above embodiments can be obtained, and the convenience of the automated driving can be ensured. In detail, in the notification control process in the sixth embodiment, the magnitude of the deceleration G occurring in the subject vehicle Am is grasped. In the notification execution process (see FIG. 24) in a case where the deceleration G exceeds the notification threshold, execution of the automatic restarting is notified as the traveling resumption information. On the other hand, in the notification execution process (see FIG. 23) in a case where the deceleration G is less than the notification threshold, the notification of the automatic restarting is omitted. Therefore, even if the subject vehicle Am stops due to interruption of another vehicle or the like, the notification of the automatic restarting can be omitted as long as the stop is in such a level that it does not surprise the driver. According to the above, it is less likely to feel the notification of the automatic restarting bothersome, and thus the convenience of the automated driving can be ensured.

In addition, when the starting condition is satisfied and the driver is monitoring the periphery in the sixth embodiment, the automated driving ECU 50b can restart the subject vehicle Am while continuing the autonomous traveling control even if the deceleration G at the emergency stop exceeds the notification threshold. In accordance with such restarting control, the notification of the automatic restarting, in a case where the deceleration G exceeds the notification threshold, does not include the hands-on notification requesting the driver to grip the steering wheel. Therefore, a situation, in which the driver starts an operation of the steering, is less likely to occur despite the fact that the autonomous traveling control can be continued. As a result, the convenience of the automated driving can be further ensured.

In the sixth embodiment, it is grasped by the information acquisition section 81 whether the periphery monitoring by the driver is being executed. Then, in the scene of the stop by the low-G emergency avoidance control or the like, the execution of the automatic restarting is notified as the traveling resumption information when the driver is not executing the periphery monitoring. On the other hand, when the driver is executing the periphery monitoring, the notification of the automatic restarting is omitted even in such a stop scene. Therefore, it is possible to avoid a situation in which the execution of the periphery monitoring by the driver is hindered by the notification of the automatic restarting. As a result, the convenience of the automated driving is less likely to be impaired.

Furthermore, when the traveling of the subject vehicle Am by the autonomous traveling control is scheduled to be resumed in the sixth embodiment, the notification of the automatic restarting is canceled from the stop until the notification start time elapses. Then, the notification of the automatic restarting is started after the notification start time elapses. Therefore, in a scene where the subject vehicle Am repeats starting and stopping under a congested traffic environment, frequent execution of the notification of the automatic restarting can be suppressed. As a result, it is less likely to feel the notification of the automatic restarting bothersome, and thus the convenience of the automated driving can be ensured.

In addition, when the subject vehicle Am that has been traveling by the autonomous traveling control stops by high-G deceleration for emergency avoidance in the sixth embodiment, the action determination section 63 resumes the traveling of the subject vehicle Am by the autonomous traveling control on condition that the driver is executing the periphery monitoring. Even if the autonomous traveling control without obligation to monitor the periphery can be continued, the driver dares to be requested to execute the periphery monitoring, as described above, whereby the sense of security of the driver can be fostered. As a result, the automated driving that the driver easily relies on can be realized.

Note that, in the sixth embodiment, the information cooperation section 61 and the information acquisition section 81 correspond to the “monitoring grasping sections” in the automated driving ECU 50b and the HCU 100, respectively.

### Seventh Embodiment

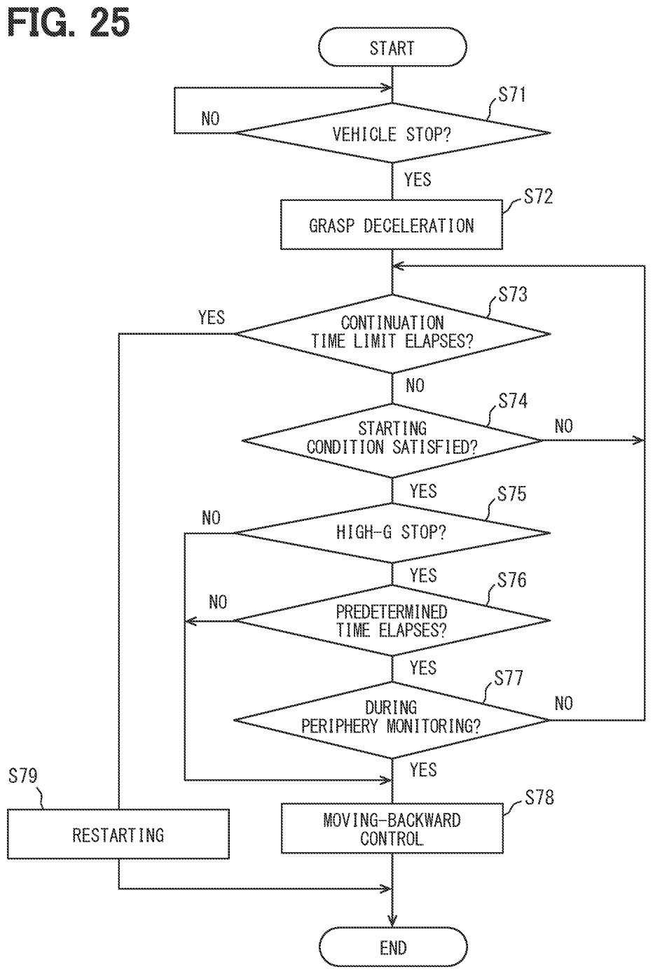

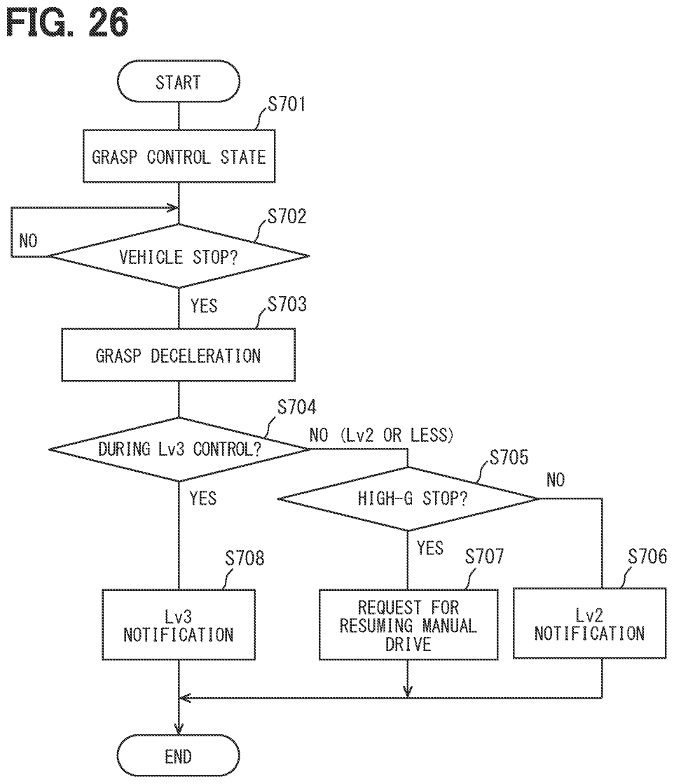

A seventh embodiment of the present disclosure illustrated in FIG. 25 and FIG. 26 is a modification of the sixth embodiment. The seventh embodiment is different from the sixth embodiment in parts of the starting control process and the notification control process. Hereinafter, details of each process in the seventh embodiment will be described.

In the starting control process illustrated in FIG. 25, when the elapsed time after the stop exceeds the continuation time limit (S73: YES), the action determination section 63 executes moving-backward control (S79). The action determination section 63 determines in the moving-backward control whether the subject vehicle Am can move backward. When determining that the subject vehicle can move backward, the action determination section 63 moves the subject vehicle Am backward by a certain distance (e.g., about 5 m). The action determination section 63 can adjust a backward movement amount in accordance with a recognition result of the periphery of the subject vehicle. The action determination section 63 determines whether the subject vehicle can move forward again after the moving backward. When determining that the subject vehicle can move forward, the action determination section 63 restarts the subject vehicle Am.

When the above moving-backward control is performed, the presentation control section 88 executes notification that urges the driver to particularly monitor the rear of the subject vehicle Am. In addition, in order to restart the subject vehicle Am after the moving backward, an input of the restarting trigger by the driver may be required. When the moving-backward control cannot be executed, the action determination section 63 terminates the automated driving, similarly to the sixth embodiment.

In addition, when the subject vehicle stops by the high-G emergency avoidance control (S75: YES), the action determination section 63 enables the restarting as long as it is before a predetermined time elapses (S76: NO) even if the periphery monitoring by the driver is not being executed. The predetermined time is set to about 30 seconds, similarly to the notification start time. Note that S71 to S75, S77, and S78 in the starting control process in the seventh embodiment are substantially the same as S61 to S67 (see FIG. 21) in the sixth embodiment.

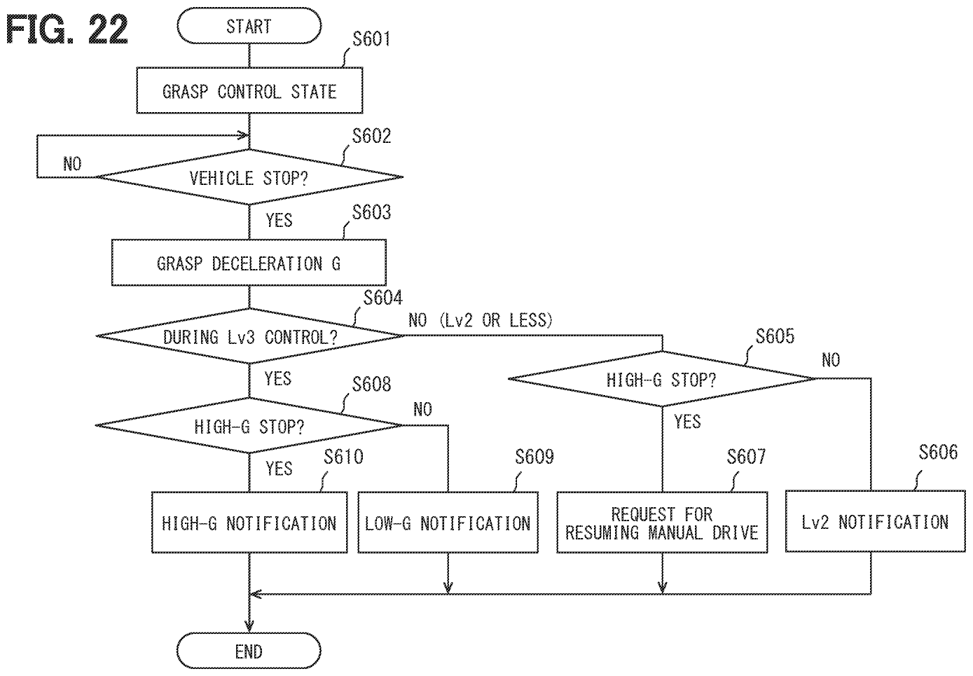

In the notification control process illustrated in FIG. 26, when the subject vehicle Am stops during the autonomous traveling control at level 3 (S704: YES), the same notification execution process (S708) is executed regardless of whether the stop is by the high-G emergency avoidance control. When it is before the notification start time elapses, the presentation control section 88 omits the notification of the traveling resumption information. On the other hand, when it is after the notification start time elapses and before the continuation time limit elapses, the notification of the automatic restarting is executed. Note that S701 to S707 in the notification control process in the seventh embodiment are substantially the same as S601 to S607 (see FIG. 22) in the sixth embodiment.

Even in the seventh embodiment described so far, the same effects as those of the sixth embodiment are obtained, and the notification of the automatic restarting can be omitted as long as the stop is in such a level that it does not surprise the driver. As a result, it is less likely to feel the notification of the automatic restarting bothersome, and thus the convenience of the automated driving can be ensured.

In the seventh embodiment, when the elapsed time after the stop exceeds the continuation time limit, the moving-backward control is executed. According to such moving-backward control, an obstacle in front of the subject vehicle, which cannot be avoided by simple steering control alone, can be avoided by traveling like going around. According to the above, the convenience of the automated driving can be further improved.

### Other Embodiments

Although a plurality of embodiments of the present disclosure have been described above, the present disclosure is not to be construed as being limited to the above embodiments, and can be applied to various embodiments and combinations without departing from the gist of the present disclosure.

The automated driving system 50 of a first modification of the above embodiment executes the same restarting control in both a case where the subject vehicle stops by the emergency avoidance control and a case where the subject vehicle stops following the preceding vehicle. Therefore, in the first modification, the process for grasping the reason for the stop of the subject vehicle Am and the process for changing the content of the traveling resumption information depending on the reason for the stop are omitted.

In the automated driving ECU 50b of a second modification of the above embodiment, the autonomous traveling control by the area level 3 is not executed. When the subject vehicle is in the AD area and the congestion around the subject vehicle is grasped, the automated driving ECU 50b executes the autonomous traveling control corresponding to the congestion level 3 in the above embodiment. Even in the second modification described above, the presentation control section 88 notifies the traveling resumption information having a content corresponding to restarting control executed by the automated driving ECU 50b.

The manner of the notification of the traveling resumption information in the above embodiment may be appropriately changed. As an example, the presentation control section 88 uses the HUD 23 in a case where a driver action for the restarting is indicated, and does not use the HUD 23 in a case where the driver action is not required. The presentation control section 88 can emphasize the information presentation in a case where the driver action is required, by making differences in the display color, display size, display luminance, and presence or absence of animation and blinking of the content used for the notification of the traveling resumption information. Furthermore, when the driver action is required, a voice message may be appropriately reproduced.

The predetermined time (semi-automatic transition time) and the continuation time limit in the above embodiment may be appropriately changed. In a third modification of the above embodiment, the semi-automatic transition time (e.g., 30 seconds), in a case where the subject vehicle is traveling on an expressway or the like, is set to be shorter than the semi-automatic transition time (e.g., 60 seconds) in a case where the subject vehicle is traveling on a general road. In a fourth modification of the above embodiment, the continuation time limit (e.g., about several minutes), in a case where the subject vehicle is traveling on an expressway or the like, is set to be longer than the continuation time limit (e.g., about 60 seconds) in a case where the subject vehicle is traveling on a general road.

In a fifth modification of the fifth embodiment, when the autonomous traveling control by the congestion level 3 is released, the traveling control state makes a transition to the driving assistance control. That is, the ACC function is in a standby state, and the subject vehicle Am is caused to remain stopped by the ACC function. In the fifth modification described above, when the elapsed time after the stop exceeds the continuation time limit, the automated driving ECU 50b starts the subject vehicle Am in the state of the driving assistance control on the basis of an input of the restarting trigger by the driver. Furthermore, the automated driving ECU 50b causes the driving assistance control to make a transition to the autonomous traveling control on the basis of the satisfaction of a predetermined level 3 transition condition.

In sixth and seventh modifications of the fifth embodiment, when the autonomous traveling control by the congestion level 3 is released, the subject vehicle Am is in the state of manual driving. In the sixth modification, when the subject vehicle Am is restarted after the continuation time limit elapses, inputs of a plurality of driver operations are required as the restarting trigger. In the seventh modification, the function of returning the autonomous traveling control is not provided. The driver starts the subject vehicle Am by the normal driving operation, and then activates the driving assistance control (ACC function) if necessary.

In an eighth modification of the above embodiment, the respective functions of the driving assistance ECU 50a and the automated driving ECU 50b are provided by one automated driving ECU. That is, the function of the driving assistance ECU 50a is implemented in the automated driving ECU 50b of the eighth modification. In the eighth modification described above, the integrated automated driving ECU corresponds to the “automated drive control device”. Furthermore, in a ninth modification of the above embodiment, the function of the HCU 100 is implemented in the automated driving ECU 50b. In such a mode, the automated driving ECU corresponds to the “automated drive control device” and the “presentation control device”.

Furthermore, when the automated drive control and the presentation control of the present disclosure are executed by the cooperation of the automated driving ECU 50b and the HCU 100, a system including the automated driving ECU 50b and the HCU 100 corresponds to the “automated drive control device” and the “presentation control device”.

In a tenth modification of the seventh embodiment, the automated driving ECU 50b has a function of switching between the congestion level 3 and the area level 3. When the subject vehicle Am stops during the traveling by the congestion level 3, the automated driving ECU 50b permits the automatic restarting regardless of the magnitude of the deceleration G, similarly to the seventh embodiment. On the other hand, when the subject vehicle Am stops during the traveling by the area level 3 by the high-G emergency avoidance control, the automated driving ECU 50b switches to manual driving. When the subject vehicle Am stops during the traveling by the area level 3 by the low-G emergency avoidance control, the automated driving ECU 50b permits the automatic restarting only when the driver is executing the periphery monitoring.

In the sixth and seventh embodiments, the magnitude of the deceleration G to be compared with the predetermined value is not limited to the maximum value. For example, the average value, time integral value, or the like of the acceleration in the deceleration direction, occurring at the time of the emergency stop, may be compared with the predetermined value, and then whether to omit the notification is switched to. Furthermore, the predetermined value for evaluating the magnitude of the deceleration G may be appropriately changed without being limited to 1 G. The predetermined value may be changeable by the driver.

In the above embodiment, the respective functions provided by the driving assistance ECU, the automated driving ECU, and the HCU can be provided by software and hardware for executing the software, only software, only hardware, or a complex combination thereof. Furthermore, when such functions are provided by electronic circuits as hardware, the respective functions can also be provided by a digital circuit or analog circuit that includes a large number of logic circuits.

Each processing section of the above embodiment is hardware for arithmetic processing coupled with a RAM. The processing section includes at least one arithmetic core such as a central processing unit (CPU) or a graphics processing unit (GPU). The processing section may further include a field-programmable gate array (FPGA), a neural network processing unit (NPU), an IP core having another dedicated function, and the like. Such a processing section may be individually mounted on a printed circuit board, or may be mounted on an application specific integrated circuit (ASIC), an FPGA, or the like.

In addition, the form of a storage medium (non-transitory tangible storage medium) that stores various programs and the like may also be appropriately changed. Such a storage medium is not limited to one provided on a circuit board, and may be one that is provided in the form of a memory card or the like to be electrically connected to the control circuit of the automated driving ECU or the HCU by being inserted into a slot portion. Furthermore, the storage medium may be an optical disk, a hard disk drive, or the like that serves as a copy base for a program for the automated driving ECU or the HCU.

The vehicle, on which the automated driving system and the HMI system are mounted, is not limited to a general private passenger car, and may be a vehicle for rental car, a vehicle for manned taxi, a vehicle for ride-sharing, a cargo vehicle, a bus, and the like. In addition, the vehicle, on which the automated driving system and the HMI system are mounted, may be a right-hand drive vehicle or a left-hand drive vehicle. Furthermore, the traffic environment in which the vehicle travels may be a traffic environment on the premise of keeping to the left or a traffic environment on the premise of keeping to the tight. The information presentation control and the automated drive control according to the present disclosure may be appropriately optimized in accordance with the road traffic law of each country and region, and further the steering wheel position of a vehicle and the like.

The control unit and the method thereof described in the present disclosure may be implemented by a special purpose computer, which includes a processor programmed to execute one or more functions performed by computer programs. Alternatively, the device and the method thereof described in the present disclosure may also be implemented by a dedicated hardware logic circuit. Alternatively, the device and the method thereof described in the present disclosure may be implemented by one or more dedicated computers configured by a combination of a processor that executes a computer program and one or more hardware logic circuits. The computer program may be stored in a computer readable non-transitory tangible storage medium as computer-executable instructions.

What is claimed is:

1. An automated drive control device that enables traveling of a subject vehicle by an automated driving function, the automated drive control device comprising:
a time determination section that, when the subject vehicle that has been traveling by autonomous traveling control in which a driver of the subject vehicle is not obliged to monitor periphery stops due to congestion, determines whether an elapsed time after the stop exceeds a predetermined time; and
a traveling control section that, when the elapsed time does not exceed the predetermined time, causes an input by the driver to not be required for resuming the traveling of the subject vehicle and that, when the elapsed time exceeds the predetermined time, resumes the traveling of the subject vehicle on a basis of an input by the driver.

2. An automated drive control device that enables traveling of a subject vehicle by an automated driving function, the automated drive control device comprising:
a time determination section that, when the subject vehicle that has been traveling by autonomous traveling control in which a driver of the subject vehicle is not obliged to monitor periphery stops due to congestion, determines whether an elapsed time after the stop exceeds a continuation time limit; and
a traveling control section that, when the elapsed time exceeds the continuation time limit, causes the autonomous traveling control to make a transition to a standby state.

3. The automated drive control device according to claim 2, wherein
when an input of a specific resuming operation by the driver is grasped after the transition to the standby state, the traveling control section terminates the standby state and resumes the operation of the autonomous traveling control.

4. The automated drive control device according to claim 2, further comprising
a notification control section that causes notification that gives a notice of termination of the autonomous traveling control to be executed before the elapsed time exceeds the continuation time limit.

5. The automated drive control device according to claim 4, wherein
the notification that gives the notice of the termination of the autonomous traveling control is emphasized more than notification that gives a notice that driving assistance control, in which the driver is obliged to monitor the periphery, is terminated due to continued stop in congestion.

6. An automated drive control device that enables traveling of a subject vehicle by an automated driving function, the automated drive control device comprising:
a time determination section that, when the subject vehicle that has been traveling by autonomous traveling control in which a driver of the subject vehicle is not obliged to monitor periphery stops due to congestion, determines whether an elapsed time after the stop exceeds a continuation time limit; and
a traveling control section that, when the elapsed time exceeds the continuation time limit, releases the autonomous traveling control,
wherein
when an input of a specific resuming operation by the driver is grasped after the autonomous traveling control is released, the traveling control section returns a traveling control state of the subject vehicle to a state of the autonomous traveling control without going through a state of driving assistance control in which the driver is obliged to monitor the periphery.

7. An automated drive control device that enables traveling of a subject vehicle by an automated driving function, the automated drive control device comprising:
a first traveling control section that controls the traveling of the subject vehicle by driving assistance control in which a driver of the subject vehicle is obliged to monitor periphery;
a second traveling control section that controls the traveling of the subject vehicle by autonomous traveling control in which the driver is not obliged to monitor the periphery; and
a monitoring grasping section that grasps whether periphery monitoring by the driver is being executed,
wherein
when the subject vehicle that has been traveling by the driving assistance control stops due to congestion, the first traveling control section causes an input by the driver to be required for restarting the subject vehicle on condition that an elapsed time after the stop exceeds a predetermined time,
when the subject vehicle that has been traveling by the autonomous traveling control stops due to congestion, the second traveling control section causes an input by the driver to not be required for restarting the subject vehicle even if the elapsed time exceeds the predetermined time, and
when the subject vehicle that has been traveling by the autonomous traveling control stops by emergency avoidance, the second traveling control section resumes the traveling of the subject vehicle by the autonomous traveling control on condition that the driver is executing the periphery monitoring.

8. A presentation control device that is used in a subject vehicle capable of traveling by an automated driving function and controls presentation of information related to the automated driving function, the presentation control device comprising:
a control grasping section that grasps whether autonomous traveling control, in which a driver of the subject vehicle is not obliged to monitor periphery, is being executed by the automated driving function;
a notification control section that, when the subject vehicle that has been traveling by the autonomous traveling control stops, notifies traveling resumption information related to resumption of the traveling of the subject vehicle; and
a monitoring grasping section that grasps whether periphery monitoring by the driver is being executed,
wherein
when the driver is not executing the periphery monitoring, the notification control section makes a notification of the traveling resumption information, and
when the driver is executing the periphery monitoring, the notification control section omits the notification of the traveling resumption information.

9. The presentation control device according to claim 8, wherein
when the stop of the subject vehicle that has been traveling by the autonomous traveling control is predicted, the notification control section starts a notification of the traveling resumption information before the subject vehicle stops.

10. The presentation control device according to claim 8, wherein
the notification control section cancels, when the traveling of the subject vehicle by the autonomous traveling control is scheduled to be resumed, a notification of the traveling resumption information until a predetermined time elapses from stop, and starts the notification of the traveling resumption information after the predetermined time elapses from the stop.

11. The presentation control device according to claim 8, wherein
when the subject vehicle that has been traveling by the autonomous traveling control stops due to congestion, the notification control section starts a notification of the traveling resumption information after a predetermined time elapses from the stop.

12. The presentation control device according to claim 8, wherein
when the subject vehicle that has been traveling by a driving assistance control in which the driver is obliged to monitor the periphery stops due to congestion, the notification control section requests a driver input for restarting the subject vehicle on a basis of a lapse of a predetermined time from the stop, and
when the subject vehicle that has been traveling by the autonomous traveling control stops due to congestion, the notification control section cancels the request of the driver input.

13. The presentation control device according to claim 8, wherein
when the subject vehicle stops, the control grasping section grasps a reason for stop of the subject vehicle, and
the notification control section changes a content of the traveling resumption information depending on the reason for the stop.

14. The presentation control device according to claim 13, wherein
when the subject vehicle stops by activation of automatic emergency braking, the notification control section notifies the traveling resumption information indicating resumption of traveling by manual driving, and
when the subject vehicle that has been traveling in congestion stops following a preceding vehicle, the notification control section notifies the traveling resumption information indicating the resumption of the traveling by the autonomous traveling control.

15. The presentation control device according to claim 8, wherein
the automated driving function is capable of switching a control mode of the autonomous traveling control among a plurality of control modes including at least congestion limited control to be executed only when traveling in congestion and area limited control to be executed only when traveling in a specific area,
the control grasping section grasps the control mode of the autonomous traveling control executed by the automated driving function, and
when the subject vehicle stops during traveling by the congestion limited control, the notification control section notifies the traveling resumption information indicating resumption of the traveling by the congestion limited control, and
when the subject vehicle stops during traveling by the area limited control, the notification control section notifies the traveling resumption information indicating the resumption of the traveling by manual driving.

16. The presentation control device according to claim 8, wherein
when the subject vehicle stops, the control grasping section grasps a magnitude of acceleration in a deceleration direction occurring in the subject vehicle,
when the acceleration exceeds a notification threshold, the notification control section makes a notification of the traveling resumption information, and
when the acceleration is less than the notification threshold, the notification control section omits the notification of the traveling resumption information.

17. The presentation control device according to claim 8, wherein
the traveling resumption information includes at least information indicating an action by the driver that is required for restarting the subject vehicle.

18. A presentation control device that is used in a subject vehicle capable of traveling by an automated driving function and controls presentation of information related to the automated driving function, the presentation control device comprising:
a control grasping section that grasps whether autonomous traveling control, in which a driver of the subject vehicle is not obliged to monitor periphery, is being executed by the automated driving function; and
a notification control section that, when the subject vehicle that has been traveling by the autonomous traveling control stops, notifies traveling resumption information related to resumption of the traveling of the subject vehicle,
wherein
when the subject vehicle stops, the control grasping section grasps a magnitude of acceleration in a deceleration direction occurring in the subject vehicle,
when the acceleration exceeds a notification threshold, the notification control section makes a notification of the traveling resumption information, and
when the acceleration is less than the notification threshold, the notification control section omits the notification of the traveling resumption information.

19. The presentation control device according to claim 18, wherein
the notification control section cancels, when the traveling of the subject vehicle by the autonomous traveling control is scheduled to be resumed, a notification of the traveling resumption information until a predetermined time elapses from stop, and starts the notification of the traveling resumption information after the predetermined time elapses from the stop.

20. The presentation control device according to claim 18, wherein
when the subject vehicle that has been traveling by the autonomous traveling control stops due to congestion, the notification control section starts a notification of the traveling resumption information after a predetermined time elapses from the stop.

21. The presentation control device according to claim 18, wherein
when gripping of a steering portion by the driver is required for resuming the traveling of the subject vehicle, the notification control section includes hands-on notification that requests the driver to grip the steering portion in the notification of the traveling resumption information, and
the notification control section does not include the hands-on notification in the notification of the traveling resumption information indicating the resumption of the traveling by the autonomous traveling control even when the acceleration exceeds the notification threshold.

22. A presentation control device that is used in a subject vehicle capable of traveling by an automated driving function and controls presentation of information related to the automated driving function, the presentation control device comprising:
a control grasping section that grasps whether autonomous traveling control, in which a driver of the subject vehicle is not obliged to monitor periphery, is being executed by the automated driving function; and
a notification control section that, when the subject vehicle that has been traveling by the autonomous traveling control stops, notifies traveling resumption information related to resumption of the traveling of the subject vehicle,
wherein
when the stop of the subject vehicle that has been traveling by the autonomous traveling control is predicted, the notification control section starts a notification of the traveling resumption information before the subject vehicle stops.

23. A presentation control device that is used in a subject vehicle capable of traveling by an automated driving function and controls presentation of information related to the automated driving function, the presentation control device comprising:
a control grasping section that grasps whether autonomous traveling control, in which a driver of the subject vehicle is not obliged to monitor periphery, is being executed by the automated driving function; and
a notification control section that, when the subject vehicle that has been traveling by the autonomous traveling control stops, notifies traveling resumption information related to resumption of the traveling of the subject vehicle,
wherein
when the subject vehicle that has been traveling by a driving assistance control in which the driver is obliged to monitor the periphery stops due to congestion, the notification control section requests a driver input for restarting the subject vehicle on a basis of a lapse of a predetermined time from the stop, and
when the subject vehicle that has been traveling by the autonomous traveling control stops due to congestion, the notification control section cancels the request of the driver input.
